(19) United States
(12) Patent Application Publication
(10) Pub. No.: US 2015/0376363 A1
(43) Pub. Date: Dec. 31, 2015

(54) POROUS MATERIAL, PRODUCING METHOD THEREOF, AND SERIAL PRODUCING APPARATUS THEREOF

(71) Applicants: Masaki WATANABE, (US); Chiaki TANAKA, (US); Yoko ARAI, (US); Satoshi IZUMI, (US); Taichi NEMOTO, (US); Takayuki SHIMIZU, (US); Shigehiro HIRANO, (US)

(72) Inventors: Masaki WATANABE, Shizuoka (JP); Chiaki TANAKA, Shizuoka (JP); Yoko ARAI, Shizuoka (JP); Satoshi IZUMI, Shizuoka (JP); Taichi NEMOTO, Shizuoka (JP); Takayuki SHIMIZU, Kanagawa (JP); Shigehiro HIRANO, Shizuoka (JP)

(73) Assignee: RICOH COMPANY, LTD., Tokyo (JP)

(21) Appl. No.: 14/762,392

(22) PCT Filed: Jan. 20, 2014
(86) PCT No.: PCT/JP2014/051592

§ 371 Date: Jul. 21, 2015

(30) Foreign Application Priority Data
Jan. 28, 2013 (JP) 2013-013758
Jan. 28, 2013 (JP) 2013-013771
Nov. 20, 2013 (JP) 2013-239436

(51) Int. Cl. C08J 9/16

(52) U.S. Cl. CPC C08J 9/16; C08J 2367/04

(57) ABSTRACT

Provided is a porous material made of at least an aliphatic polyester resin or an aliphatic polycarbonate resin, and having a porosity of 70% or higher, wherein a polystyrene equivalent weight average molecular weight of the resin measured by gel permeation chromatography is 300,000 or greater.

### TECHNICAL FIELD

The present invention relates to a porous material, a producing method thereof, and a serial producing apparatus thereof.

### BACKGROUND ART

Recently, resin porous materials are used as shock absorbing material, reflection plate, heat insulating material, sound insulating material, etc., with their lightness, cushioning properties, and heat insulating properties taken advantage of. Therefore, resin porous materials are required to have both of high strength and high porosity at the same time. Polyester resin porous materials and polycarbonate resin porous materials have drawbacks in that their hydrolysis resistance and durability against a long time of use are poor, and they cannot endure practical use. Under these circumstances, these porous materials are required to have high porosity, high strength, and high hydrolysis resistance all at the same time.

As a porous material, there is proposed a heat insulating material, of which porosity is enhanced by making its pore diameter distribution bimodal (see, e.g., PTL 1).

In order to improve the heat insulating effect, it is preferable to make the porous material contain a carbonic acid gas. However, the problem is that it is difficult to make small diameter pores contain a sufficient amount of carbonic acid gas. Further, when the material is used for a casing or the like, it is necessary to enhance the strength much more.

There is also proposed a porous material, of which strength and heat resistance are enhanced by using a crystallization nucleating agent (see, e.g., PTL 2).

However, there is a problem that sufficient levels of porosity and strength are not achieved at the same time.

As can be understood from the above, conventional polyester resin or polycarbonate resin porous materials have not been able to have high porosity, high strength, and high hydrolysis resistance at the same time.

Therefore, currently, it is requested to provide a porous material that is made of a polyester resin, a polycarbonate resin, or both thereof and has high porosity, high strength, and high hydrolysis resistance at the same time.

### CITATION LIST

### Patent Literature

[PTL 1] International Publication No. 2009/110587

[PTL 2] Japanese Patent Application Laid-Open (JP-A) No. 2005-206771

### DISCLOSURE OF INVENTION

The present invention aims to solve the conventional problems described above and achieve the following object. That is, an object of the present invention is to provide a porous material that is made of a polyester resin, a polycarbonate resin, or both thereof and has high porosity, high strength, and high hydrolysis resistance at the same time.

Means for solving the problems is as follows.

A porous material of the present invention is made of an aliphatic polyester resin, an aliphatic polycarbonate resin, or both thereof, and has a porosity of 70% or greater, wherein a polystyrene equivalent weight average molecular weight of the resin measured by gel permeation chromatography is 300,000 or greater.

The present invention can provide a porous material that can solve the conventional problems described above, is made of a polyester resin, a polycarbonate resin, or both thereof, and has high porosity, high strength, and high hydrolysis resistance at the same time.

### BRIEF DESCRIPTION OF DRAWINGS

FIG. 1 is a common phase diagram showing states of a substance with respect to temperature and pressure.

FIG. 2 is a phase diagram defining the range of a compressive fluid.

FIG. 3 is a system line diagram showing an example serial polymerizing step.

FIG. 4 is a system line diagram showing an example serial polymerizing step.

FIG. 5A is an exemplary diagram showing a producing system used in a first method.

FIG. 5B is an exemplary diagram showing a producing system used in a first method.

FIG. 6 is an exemplary diagram showing a producing system used in a second method.

FIG. 7 is a system line diagram showing an example batch polymerizing step.

### BEST MODE FOR CARRYING OUT THE INVENTION

### (Porous Material and Porous Material Producing Method)

A porous material of the present invention (hereinafter may be referred to as “resin porous material”) is made of an aliphatic polyester resin, an aliphatic polycarbonate resin, or both thereof.

The porous material producing method of the present invention includes at least a polymerizing step and a porosity imparting step, and includes other steps according to necessity.

### <Porosity>

The porosity of the porous material is 70% or greater, preferably from 70% to 98%, and more preferably from 80% to 98%.

With a porosity of 70% or greater, the porous material can exert its properties such as heat insulating property, sound insulating property, shock absorbing property, reflecting plate property, adsorbing property, and catalytic activity sufficiently. Further, when the porous material is made of an aliphatic polyester resin, hydrolysis resistance of the porous material is excellent, provided that the porosity is 70% or greater.

When the porosity is less than 70%, the properties of the porous material such as heat insulating property, sound insulating property, shock absorbing property, reflecting plate property, adsorbing property, and catalytic activity might be insufficient. Furthermore, when the porous material is shaped into a product, the weight of the resulting product might be excessively large.

When the porosity is greater than 98%, the strength of the porous material might be degraded.

The average pore diameter of the porous material is not particularly limited and may be appropriately selected according to the purpose. However, it is preferably from 10 μm to 1,000 μm, more preferably from 20 μm to 500 μm, and particularly preferably from 40 μm to 80 μm. When the average pore diameter is greater than 1,000 μm, a sufficiently small shaped product may not be manufactured, or adsorbing property, catalytic activity, etc. may be insufficient.

The average pore wall thickness of the porous material is not particularly limited and may be appropriately selected according to the purpose. However, it is preferably 1 μm or less, and more preferably 0.5 μm or less. When the average pore wall thickness is 1 μm or less, the hydrolysis resistance may be improved. When it is greater than 1 μm, the porosity of the porous material may be low, which may make it impossible to manufacture a sufficiently light-weight shaped product.

The lower limit of the average pore wall thickness is not particularly limited and may be appropriately selected according to the purpose. However, it is preferably 0.2 μm. When the average pore wall thickness is less than 0.2 μm, a sufficient strength may not be achieved.

The porosity, the average pore diameter, and the average pore wall thickness can be measured by, for example, SEM observation. Specifically, they can be measured according to the following manner.

A cross-section of the porous material is observed with a scanning electro microscope (FE-SEM) manufactured by JEOL Ltd. An image analyzing software program IMAGE-PRO PLUS is used for image analysis. A microtome is used for exposing a cross-section of the porous material. Microscopic observation of the average porous diameter is performed at the magnification shown in Table 1 below. Microscopic observation of the average pore wall thickness is performed at the magnification shown in Table 2 below.

Specifically, the porosity is obtained according to the following manner, for example.

A cross-section of the porous material is expanded such that one side thereof may be observed in an image range of 500 μm, and a photograph of the expanded cross-section is captured.

A transparent sheet (such as an OHP sheet) is placed over the captured photograph, and portions corresponding to the pores are solidly blackened with a black ink.

The transparent sheet blackened with the black ink is imaged to recognize the portions blackened with the black ink with the image analyzing software, obtain the area of the portions blackened with the black ink, i.e., the area (Va) of the pores, and calculate the voidage (X) according to the following formula.

Porosity %=[area of the pores(Va)/area of the whole image]×100

The number of samples to be measured is 5 (n=5), and the average of the 5 samples is used as porosity (X).

Specifically, the average pore diameter is obtained according to the following manner, for example.

At each microscope magnification shown in Table 1 below, 100 pores are randomly selected, and their circle equivalent diameter is obtained. A histogram at each magnification is generated. Note that any pore, of which pore diameter cannot be wholly observed, such as one that is present at an edge of a SEM image, is not to be measured.

By setting a lower limit (or an upper limit) to the sampling of pores at each magnification, it is ensured that the same pore may not be measured twice.

The histograms at the respective magnifications thusly obtained are linked with each other as a pore diameter distribution of the porous material. A median size is used as the average pore diameter.

Specifically, the average pore wall thickness is obtained according to the following manner, for example.

At each microscope magnification shown in Table 2 below, 100 pores are randomly selected, and their pore wall thickness is obtained. A histogram at each magnification is generated. By setting a lower limit (or an upper limit) to the sampling of pore wall thickness at each magnification, it is ensured that the same wall may not be measured twice.

The histograms at the respective magnifications thusly obtained are linked with each other as a pore wall thickness distribution of the porous material. A median thickness is used as the average pore wall thickness.

TABLE 1

| Pore diameter | Magnification | Width of histogram | |
|---|---|---|---|
| Less than 1 μm | ×10,000 | 0.1 | μm |
| 1 μm or greater but | ×200 | 1 | μm |
| less than 10 μm | | | |
| 10 μm or greater but | ×200 | 10 | μm |
| less than 100 μm | | | |
| 100 μm or greater | ×50 | 100 | μm |

TABLE 2

| Pore wall thickness | Magnification | Width of histogram | |
|---|---|---|---|
| Less than 1 μm | ×10,000 | 0.1 | μm |
| 1 μm or greater | ×5,000 | 1 | μm |

### <Weight Average Molecular Weight>

The polystyrene equivalent weight average molecular weight of the resin measured by gel permeation chromatography is 300,000 or greater, preferably from 300,000 to 1,000,000, and more preferably from 400,000 to 1,000,000. When the weight average molecular weight is 300,000 or greater, it is possible to obtain a porous material that has high porosity and has high strength even if the pore wall thickness thereof is small. When the weight average molecular weight is less than 30,000, the strength of the porous material will be insufficient. When the weight average molecular weight is 1,000,000 or less, workability of the porous material will be excellent.

It is possible to adjust the weight average molecular weight by adjusting the amount of an initiator in the polymerizing step, for example.

A value (Mw/Mn) obtained by dividing the weight average molecular weight Mw of the porous material by a number average molecular weight Mn thereof is not particularly limited and may be appropriately selected according to the purpose. However, it is preferably from 1.0 to 2.5, and more preferably from 1.0 to 2.0. When the value (Mw/Mn) is greater than 2.0, it is probable that the polymerization reaction has progressed non-uniformly, which may make it difficult to control the physical properties of the resin.

The weight average molecular weight and a molecular weight distribution [i.e., the value (Mw/Mn)] can be obtained by gel permeation chromatography (GPC).

Specifically, they can be measured according to the following method.

The measurement is performed under the following conditions according to GPC (Gel Permeation Chromatography).
Instrument: GPC-8020 (manufactured by Tosoh Corporation)
Columns: TSK G2000HXL and G4000HXL (manufactured by Tosoh Corporation)
Temperature: 40° C.
Solvent: chloroform
Flow rate: 1.0 mL/minute

With the use of a molecular weight calibration curve generated based on a monodisperse polystyrene standard sample, the number average molecular weight (Mn) and the weight average molecular weight (Mw) of the polymer are calculated from the distribution of molecular weights of the polymer obtained by injecting a sample having a concentration of 0.5% by mass (1 mL) and measuring it under the above conditions. The molecular weight distribution is a value obtained by dividing Mw by Mn. The porous material is dissolved in chloroform at a concentration of 0.2% by mass, and then filtered through a 0.2 μm filter. The resulting filtrate is used as the sample.

### <Polymerizing Step>

The polymerizing step is not particularly limited and may be appropriately selected according to the purpose, as long as it is a step of ring-opening polymerizing a monomer in a mixture.

The mixture contains at least the monomer and a compressive fluid, preferably contains a filler material, and further contains other components according to necessity.

The polymerizing step may be performed serially or batch wise.

When the mixture contains an inorganic material, which is a filler material, the porous material will be an organo-inorganic hybrid porous material.

### —Monomer—

The monomer (hereinafter may be referred to as “polymerizable monomer”) is not particularly limited and may be appropriately selected according to the purpose. However, it is preferably a ring-opening-polymerizable monomer.

The ring-opening-polymerizable monomer is not particularly limited and may be appropriately selected according to the purpose. However, it is preferably a ring-opening-polymerizable monomer that contains a carbonyl group in the ring. The carbonyl group is constituted by a π-bond between highly electronegative oxygen and carbon. In the carbonyl group, oxygen attracts π-bond electrons to thereby have itself polarize negatively and have carbon polarize positively. Therefore, the carbonyl group is highly reactive. When the compressive fluid is carbon dioxide, it is estimated that the level of affinity between carbon dioxide and the polymer to be obtained will be high, because the carbonyl group is similar to the structure of carbon dioxide. Assisted by these effects, an effect of plasticization by the compressive fluid to the polymer to be obtained will be high. A ring-opening-polymerizable monomer containing a carbonyl group in the ring is not particularly limited and may be appropriately selected according to the purpose. However, it is preferably a ring-opening-polymerizable monomer containing an ester bond.

The ring-opening-polymerizable monomer is not particularly limited and may be appropriately selected according to the purpose. Examples thereof include cyclic ester and cyclic carbonate. When a cyclic ester is ring-opening polymerized, an aliphatic polyester resin is obtained. When a cyclic carbonate is ring-opening-polymerized, an aliphatic polycarbonate resin is obtained.

### ——Cyclic Ester——

The cyclic ester is not particularly limited and may be appropriately selected according to the purpose. However, preferable are cyclic dimers obtained by dehydration-condensing an L-form, a D-form, or both thereof of a compound represented by General Formula (1) below.

R—C*—H(—OH)(—COOH) General Formula (1)

In General Formula (1), R represents an alkyl group containing 1 to 10 carbon atoms, and C* represents asymmetric carbon.

The compound represented by General Formula (1) above is not particularly limited and may be appropriately selected according to the purpose. Examples thereof include enantiomers of lactic acid, enantiomers of 2-hydroxybutanoic acid, enantiomers of 2-hydroxypentanoic acid, enantiomers of 2-hydroxyhexanoic acid, enantiomers of 2-hydroxyheptanoic acid, enantiomers of 2-hydroxyoctanoic acid, enantiomers of 2-hydroxynonanoic acid, enantiomers of 2-hydroxydecanoic acid, enantiomers of 2-hydroxyundecanoic acid, and enantiomers of 2-hydroxydodecanoic acid. Among these, enantiomers of lactic acid are particularly preferable since they are highly reactive and readily available.

The cyclic ester is not particularly limited and may be appropriately selected according to the purpose. Examples thereof include aliphatic lactone. The aliphatic lactone is not particularly limited and may be appropriately selected according to the purpose. Examples thereof include β-propiolactone, β-butyrolactone, γ-butyrolactone, γ-hexanolactone, γ-octanolactone, δ-valerolactone, δ-hexanolactone, δ-octanolactone, ε-caprolactone, δ-dodecanolactone, α-methyl-γ-butyrolactone, β-methyl-δ-valerolactone, glycolide and lactide. Among these, ε-caprolactone is preferable since it is highly reactive and readily available.

### ——Cyclic Carbonate——

The cyclic carbonate is not particularly limited and may be appropriately selected according to the purpose. Examples thereof include ethylene carbonate and propylene carbonate.

One of these ring-opening-polymerizable monomer may be used alone, or two or more of these may be used in combination.

### —Compressive Fluid—

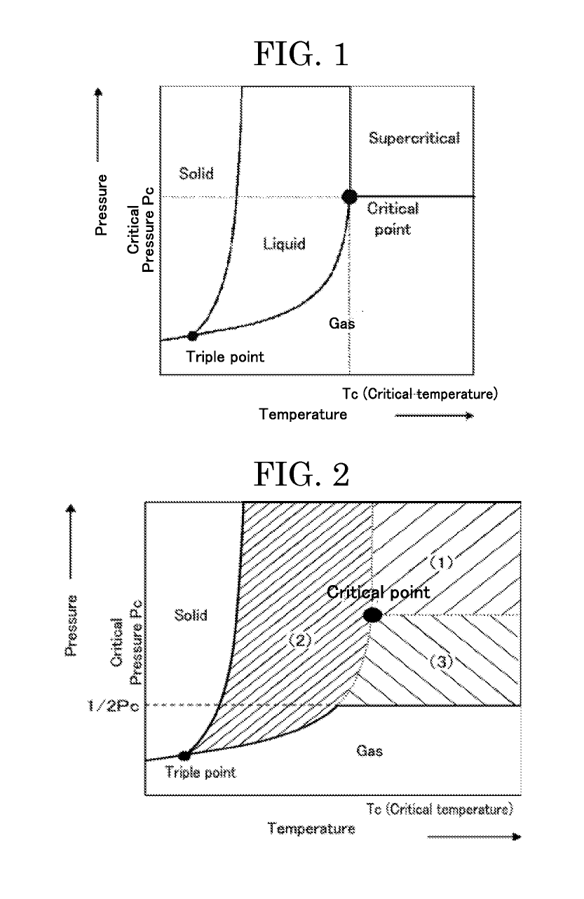

The compressive fluid will be explained with reference to FIG. 1 and FIG. 2. FIG. 1 is a phase diagram showing states of a substance with respect to temperature and pressure. FIG. 2 is a phase diagram for defining the range of the compressive fluid. A “compressive fluid” means a fluid in a state when it is present in any of (1), (2), and (3) shown in FIG. 2 in the phase diagram shown in FIG. 1.

In these regions, a substance is known to have a very high density and show different behaviors from when it is at normal temperature and normal pressures. When a substance is in the region (1), it is a supercritical fluid. A supercritical fluid is a fluid that exists as a non-condensable high-density fluid in a temperature/pressure region above a limit (critical point) until which a gas and a liquid can coexist, and does not condense when compressed. When a substance is in the region (2), it is a liquid. However, in the present invention, a substance in the region (2) means a liquefied gas obtained by compressing a substance that has a gaseous state at normal temperature (25° C.) and normal pressures (1 atm). When a substance is in the region (3), it has a gaseous state. However, in the present invention, a substance in the region (3) means a high-pressure gas, of which pressure is equal to or higher than ½ of the critical pressure (Pc), i.e., ½Pc or higher.

Examples of the substance to constitute the compressive fluid is not particularly limited and may be appropriately selected according to the purpose. Examples thereof include carbon monoxide, carbon dioxide, dinitrogen monoxide, nitrogen, methane, ethane, propane, 2,3-dimethylbutane, and ethylene. Among these, carbon dioxide is preferable, because a supercritical state thereof is easy to produce since the critical pressure thereof is about 7.4 MPa and the critical temperature thereof is about 31° C., and because it is incombustible and easy to handle. One of these compressive fluids may be used alone, or two or more of these may be used in combination.

Carbon dioxide is reactive with a substance having basicity and nucleophilicity. Therefore, conventionally, carbon dioxide has been considered unable to use as a solvent when performing living anion polymerization (see “Latest Applied Technique for Using Supercritical Fluid”, page 173, Mar. 15, 2004, published by NTS Incorporation). However, the present inventors have overthrown the conventional findings. That is, the present inventors have found out that even under supercritical carbon dioxide, a catalyst having basicity and nucleophilicity stably coordinates to a ring-opening-polymerizable monomer to ring-open the ring-opening-polymerizable monomer, to thereby allow the polymerization reaction to progress quantitatively in a short time, to consequently allow the polymerization reaction to progress in a living fashion. The living fashion here means that a reaction progresses quantitatively without side reactions such as migration reaction and termination reaction, to thereby result in a polymer product, of which molecular weight distribution is relatively narrow and monodisperse.

### —Filler Material—

The filler material is not particularly limited and may be appropriately selected according to the purpose. Examples thereof include inorganic material, carbon fiber, and macromolecular polysaccharide.

### ——Inorganic Material——

The inorganic material is not particularly limited and may be appropriately selected according to the purpose. Examples thereof include silica, clay, talc, ferrite, titanium oxide, zirconium oxide, barium titanate, magnesium hydroxide, hydroxy apatite, β-tricalcium phosphate, aluminum nitride, and silicon nitride. Among these, use of hydroxy apatite and β-tricalcium phosphate is particularly preferable because they can impart biocompatibility to the porous material.

The shape of the inorganic material is not particularly limited and may be appropriately selected according to the purpose. Examples thereof include a granular shape.

The inorganic material is different from a metal catalyst described later.

The content of the inorganic material in the porous material is not particularly limited and may be appropriately selected according to the purpose. However, it is preferably from 5% by mass to 95% by mass, more preferably from 15% by mass to 85% by mass, and particularly preferably from 30% by mass to 80% by mass relative to the porous material.

These preferable ranges are generally applicable for any of the inorganic materials listed above, but are more applicable when the inorganic material is a biocompatible material (e.g., hydroxyapatite and β-tricalcium phosphate).

For example, when the porous material is used as a biocompatible material (e.g., an artificial bone), the biocompatibility might be degraded when the content is less than 5% by mass, whereas the mechanical strength might be degraded when the content is greater than 95% by mass. It is advantageous if the content is within the particularly preferable range, because biocompatibility and mechanical strength will both be satisfied, and besides, productivity is excellent.

When an inorganic material having a reaction activity is used as the inorganic material for producing the porous material, it might take time for the resulting polymer to achieve a sufficient molecular weight, when the content is greater than 95% by mass.

### ——Carbon Fiber——

The carbon fiber is not particularly limited and may be appropriately selected according to the purpose. A preferable example thereof is a fiber material, of which carbon content is from 85% by mass to 100% by mass, and that at least partially contains a graphite structure. Examples of the carbon fiber include polyacrylonitrile (PAN)-based carbon fiber, rayon-based carbon fiber, lignin-based carbon fiber, pitch-based carbon fiber, vapor-grown carbon fiber, carbon nanotube, and carbon nanohorn. Among these, carbon fibers that are free from a reactive functional group, i.e., carbon nanotube and carbon nanohorn are preferable.

The shape of the carbon fiber is not particularly limited and may be appropriately selected according to the purpose. Examples thereof include multilayer carbon nanotube and single-layer carbon nanotube.

The content of the carbon fiber in the porous material is not particularly limited and may be appropriately selected according to the purpose. However, it is preferably from 0.1% by mass to 25% by mass, more preferably from 1% by mass to 12% by mass, and particularly preferably from 3% by mass to 8% by mass relative to the porous material. These preferable ranges are generally applicable for any of the carbon fibers listed above, but are more applicable when carbon nanotube is used as the carbon fiber. For example, when the porous material is used as a biocompatible material (e.g., an artificial bone) with 30% by mass of hydroxy apatite added as the inorganic material, the effect of improving the mechanical strength may not be obtained when the content of the carbon fiber is less than 0.1% by mass, whereas when the content thereof is greater than 25% by mass, not only the biocompatibility may be degraded, but also the mechanical strength may be degraded because the degree of hardness would be reduced. It is advantageous if the content is within the particularly preferable range, because biocompatibility and mechanical strength will both be satisfied, and besides, productivity is excellent. When a carbon fiber that contains a reactive functional group is used as the carbon fiber for producing a carbon fiber composite porous material as the porous material, the molecular weight of the resulting polymer might be low, when the content of the carbon fiber is greater than 25% by mass.

### ——Macromolecular Polysaccharide——

The macromolecular polysaccharide is not particularly limited and may be appropriately selected according to the purpose. Examples thereof include cellulose, chitin, chitosan, dextran, and alginic acid. When it is desirable for the resin, which is to be obtained in the polymerizing step, to have a high molecular weight, it is preferable to use a macromolecular polysaccharide, of which hydroxyl group is acetylated, to a particularly preferable acetification degree of 50% by mass or greater. When it is desirable to suppress the bioaccumulation potential, bioabsorbable polysaccharides such as chitin and dextran are preferable.

The content of the macromolecular polysaccharide in the porous material is not particularly limited and may be appropriately selected according to the purpose. However, it is preferably from 0.01% by mass to 25% by mass, more preferably from 0.05% by mass to 10% by mass, and particularly preferably from 0.1% by mass to 5% by mass. When the content of the macromolecular polysaccharide is less than 0.01% by mass, an effect of improving physical properties may not be obtained. When it is greater than 25% by mass, there will be too much macromolecular polysaccharide to thereby provide too many hydroxyl groups, which can function as a kind of an initiator, the molecular weight of the resin to be obtained in the polymerizing step may not be grown sufficiently, and desirable properties may not be obtained.

### —Other Components—

The other components mentioned above are not particularly limited and may be appropriately selected according to the purpose. Examples thereof include an initiator, a catalyst, and an additive.

### ——Initiator——

The initiator is used for controlling the molecular weight of the polymer to be obtained by ring-opening polymerization. The initiator is not particularly limited and may be appropriately selected according to the purpose. For example, when the initiator is an alcohol, it may be either of aliphatic monoalcohol and aliphatic polyhydric alcohol, and it may be either of saturated alcohol and unsaturated alcohol. Examples of the initiator include monoalcohol, polyhydric alcohol, and lactic acid ester. Examples of the monoalcohol include methanol, ethanol, propanol, butanol, pentanol, hexanol, heptanol, nonanol, decanol, lauryl alcohol, myristyl alcohol, cetyl alcohol, and stearyl alcohol. Examples of the polyhydric alcohol include: dialcohol such as ethylene glycol, 1,2-propanediol, 1,3-propanediol, 1,3-butanediol, 1,4-butanediol, hexanediol, nonanediol, tetramethylene glycol, and polyethylene glycol; glycerol; sorbitol; xylitol; ribitol; erythritol; and triethanol amine. The lactic acid ester is not particularly limited and may be appropriately selected according to the purpose. Examples thereof include methyl lactate, and ethyl lactate. One of these may be used alone, or two or more of these may be used in combination.

A polymer containing an alcohol residue at the terminal, such as polycaprolactonediol and polytetramethyleneglycol may also be used as the initiator. Use of such an initiator allows for synthesizing a diblock copolymer, a triblock copolymer, or the like.

The amount of use of the initiator in the polymerizing step may be appropriately adjusted according to the target molecular weight. It is preferably from 0.1 mol % to 5 mol % relative to the ring-opening-polymerizable monomer. In order to prevent the polymerization from being initiated non-uniformly, it is preferable to mix the monomer and the initiator well in advance of bringing the monomer into contact with the catalyst.

### ——Catalyst——

The catalyst is not particularly limited and may be appropriately selected according to the purpose. Examples thereof include an organic catalyst and a metal catalyst.

### ———Organic Catalyst———

The organic catalyst is not particularly limited and may be appropriately selected according to the purpose. A preferable organic catalyst is a catalyst that does not contain metal atoms, contributes to the ring-opening polymerization reaction of the ring-opening-polymerizable monomer, and can be desorbed through reaction with an alcohol and reclaimed after it forms an active intermediate with the ring-opening-polymerizable monomer.

For example, for polymerization of a ring-opening-polymerizable monomer containing an ester bond, the organic catalyst is not particularly limited and may be appropriately selected according to the purpose. However, it is preferably a (nucleophilic) compound that functions as a nucleophile having basicity, more preferably a compound containing a nitrogen atom, and particularly preferably a cyclic compound containing a nitrogen atom. Such a compound is not particularly limited and may be appropriately selected according to the purpose. Examples thereof include cyclic monoamine, cyclic diamine (e.g., a cyclic diamine compound having an amidine skeleton), a cyclic triamine compound having a guanidine skeleton, a heterocyclic aromatic organic compound containing a nitrogen atom, and N-heterocyclic carbene. A cationic organic catalyst may be used for ring-opening polymerization. However, in this case, the catalyst may withdraw hydrogen from the main chain of the polymer (back-biting) to broaden the molecular weight distribution, which makes it difficult to obtain a product having a high molecular weight.

The cyclic monoamine is not particularly limited and may be appropriately selected. Examples thereof include quinuclidine.

Examples of the cyclic diamine include 1,4-diazabicyclo-[2.2.2]octane (DABCO) and 1,5-diazabicyclo(4,3,0)-5-nonene. Examples of the cyclic diamine compound having an amidine skeleton include 1,8-diazabicyclo[5.4.0]undec-7-ene (DBU) and diazabicyclononene.

The cyclic triamine compound having a guanidine skeleton is not particularly limited and may be appropriately selected according to the purpose. Examples thereof include 1,5,7-triazabicyclo[4.4.0]dec-5-ene (TBD) and diphenylguanidine (DPG). The heterocyclic aromatic organic compound containing a nitrogen atom is not particularly limited and may be appropriately selected according to the purpose. Examples thereof include N,N-dimethyl-4-aminopyridine (DMAP), 4-pyrrolidinopyridine (PPY), pyrrocolin, imidazole, pyrimidine and purine. The N-heterocyclic carbene is not particularly limited and may be appropriately selected. Examples thereof include 1,3-di-tert-butylimidazol-2-ylidene (ITBU). Among these, DABCO, DBU, DPG, TBD, DMAP, PPY, and ITBU are preferable, as they have high nucleophilicity without being greatly affected by steric hindrance, or they have such boiling points that they can be removed at a reduced pressure.

Among these organic catalysts, for example, DBU has a liquid state at room temperature and has a boiling point. When such an organic catalyst is selected, it is possible to substantially quantitatively remove the organic catalyst from the obtained polymer by treating the polymer at a reduced pressure. The kind of the organic catalyst and whether or not to perform the treatment for removing it are determined according to for what application the product to be obtained is used.

### ———Metal Catalyst———

The metal catalyst is not particularly limited and may be appropriately selected according to the purpose. Examples thereof include a tin-based compound, an aluminum-based compound, a titanium-based compound, a zirconium-based compound, and an antimony-based compound. Examples of the tin-based compound include tin octylate, tin dibutylate, and tin di(2-ethylhexanoate). Examples of the aluminum-based compound include aluminum acetyl acetonate and aluminum acetate. Examples of the titanium-based compound include tetraisopropyl titanate and tetrabutyl titanate. Examples of the zirconium-based compound include zirconium isopropoxide. Examples of the antimony-based compound include antimony trioxide.

The kind and amount of use of the catalyst cannot be flatly specified because they depend on the combination of the compressive fluid and the ring-opening-polymerizable monomer. However, the amount of use thereof is preferably from 0.01 mol % to 15 mol %, more preferably from 0.1 mol % to 1 mol %, and particularly preferably from 0.3 mol % to 0.5 mol % relative to the ring-opening-polymerizable monomer. When the amount of use thereof is less than 0.01 mol %, the catalyst will get deactivated before the polymerization reaction is completed, which may make it impossible to obtain a polymer having the target molecular weight. On the other hand, when the amount of use thereof is greater than 15 mol %, it may be difficult to control the polymerization reaction.

As the catalyst to be used in the polymerizing step, the organic catalyst (an organic catalyst free from metal atoms) is preferably used for the applications in which safeness and stability are required of the product to be obtained.

### ——Additive——

In the polymerizing step, an additive may be added according to necessity. The additive is not particularly limited and may be appropriately selected according to the purpose. Examples thereof include a surfactant and an antioxidant.

As the surfactant, one that melts in the compressive fluid and has affinity with both of the compressive fluid and the ring-opening-polymerizable monomer is preferably used. Use of such a surfactant allows the polymerization reaction to progress uniformly, making it possible to obtain a product having a narrow molecular weight distribution, and making it easier to obtain a polymer in a particle state. When the surfactant is used, it may be added to the compressive fluid or it may be added to the ring-opening-polymerizable monomer. For example, when carbon dioxide is used as the compressive fluid, a surfactant containing a carbon dioxide-philic group and a monomer-philic group in the molecule is used. Such a surfactant is not particularly limited and may be appropriately selected according to the purpose. Examples thereof include a fluorine-based surfactant and a silicone-based surfactant.

In the polymerizing step, a polymerization reaction at a low temperature can be realized with the use of the compressive fluid. Therefore, as compared with conventional melt polymerization, depolymerization can be greatly suppressed. This can realize a polymer conversion rate of 96 mol % or greater, preferably 98 mol % or greater. When the polymer conversion rate is less than 96 mol %, a polymer-containing product to be obtained will have an insufficient thermal characteristic, which may make it necessary to perform an additional operation for removing the ring-opening-polymerizable monomer. Polymer conversion rate here means a rate of ring-opening-polymerizable monomer contributed to polymer production to ring-opening-polymerizable monomer as the raw material. The amount of ring-opening-polymerizable monomer contributed to polymer production can be obtained by subtracting the amount of unreacted ring-opening-polymerizable monomer (the amount of residual ring-opening-polymerizable monomer) from the amount of produced polymer.

The polymer is preferably a copolymer that contains 2 or more kinds of polymer segments. The polymer is also preferably a stereo complex. Here, to explain by taking a stereo complex polylactic acid for example, a “stereo complex” means a polylactic acid composition that contains a poly D-lactic acid component and a poly L-lactic acid component, that contains a stereo complex crystal, and that has a stereo complex crystallinity of 90% or greater, where the stereo complex crystallinity is expressed by the following formula (i). Stereo complex crystallinity (S) can be calculated from the following formula (i) based on heat of melting (ΔHmh) of a polylactic acid homocrystal that is observed at lower than 190° C. in differential scanning calorimetry (DSC), and heat of melting (ΔHmsc) of a polylactic acid stereo complex that is observed at 190° C. or higher in differential scanning calorimetry.

(S)=[ΔHmsc/(ΔHmh+ΔHmsc)]×100 (i)

### <Porosity Imparting Step>

The porosity imparting step is not particularly limited and may be appropriately selected according to the purpose, as long as it is a step of making the resin obtained in the polymerizing step porous by rapidly expanding the compressive fluid.

The porosity imparting step is preferably a step of further mixing the resin obtained in the polymerizing step with a second compressive fluid, and then rapidly expanding the compressive fluid and the second compressive fluid.

By rapidly expanding the compressive fluid (and the second compressive fluid) in the state that the resin and the compressive fluid (and the second compressive fluid) are brought into contact with each other, it is possible to impart porosity to the resin while the resin is sufficiently permeated with the compressive fluid (and the second compressive fluid). This can impart a high porosity to the porous material to be obtained.

In the porosity imparting step, it is preferable that the ratio of the compressive fluid to the resin be higher than the ratio thereof in the polymerizing step. With a higher ratio, a porous material with a high porosity and with a small pore wall thickness can be obtained.

For example, the second compressive fluid may be the same compressive fluid as the compressive fluid in the mixture, or may be different from this.

The rate of the rapid expansion is not particularly limited and may be appropriately selected according to the purpose as long as it is such a rate of expanding the compressive fluid at which the resin that contains the compressive fluid will be porous when the compressive fluid is expanded. However, it is preferable to reduce pressure at a rate of 10 MPa/s or higher. It is more preferable to reduce pressure at a rate of 20 MPa/s or higher.

The advantages of the porous material producing method of the present invention will be described below, while also describing conventional techniques.

Generally, organic resins are easy to manufacture into a desired shape, because they have excellent shapability and flexibility. However, on the other hand, they may be inferior to inorganic materials in heat resistance, chemical stability, etc.

On the other hand, inorganic materials such as metal and ceramics are excellent in heat resistance, mechanical strength, electric characteristic, optical characteristic, chemical stability, etc. Therefore, inorganic materials are widely used for industrial applications, with these functionalities taken advantage of. However, inorganic materials are generally brittle and have a high hardness. Therefore, in order to manufacture them into a desired shape, it is necessary to form them into the shape at a high temperature or mechanically machine them, which may limit the applications of the inorganic materials.

Hence, recently, attention has been paid to an organo-inorganic hybrid porous material in which an inorganic material such as metal and ceramic and an organic resin are hybridized to have characteristics of both of them. An organo-inorganic hybrid porous material is especially paid attention because it has characteristics of the inorganic material such as adsorbing property and catalytic activity and characteristics of the organic resin such as shapability and flexibility at the same time.

Organo-inorganic hybridization is practiced in order to improve characteristics, particularly, wear resistance and heat resistance of, for example, thermosetting resin such as phenol resin or thermoplastic resin such as polylactic acid resin. Specifically, there is proposed an organo-inorganic hybrid composition that is composed of an organic synthetic resin and silica particles minutely and substantially uniformly dispersed therein, and that is obtained by mixing liquid glass in an aqueous emulsion of the organic synthetic resin and by further adding an acid thereto to thereby agglutinate the organic synthetic resin and silica sol (see, e.g., JP-A No. 2003-277509). However, this proposed technique requires synthesis of an organic resin, emulsification of the organic resin, mixing of the emulsion with an inorganic material, and removal of water by drying, which is problematic in that many steps are necessary for hybridization. Furthermore, it is probable that the solvent used for producing the organo-inorganic hybrid material may remain in the obtained organo-inorganic hybrid material.

There is also proposed an organo-inorganic hybrid material that is obtained by hybridizing a biocompatible inorganic material such as hydroxy apatite with a biocompatible natural polymer such as agarose and chitosan (see, e.g., JP-A No. 2004-026653). However, this proposed technique uses a natural polymer as the organic resin, which is problematic in that the mechanical strength is poor.

Therefore, it is currently requested to provide an organo-inorganic hybrid material that can be manufactured without many steps and has excellent mechanical strength.

As the organo-inorganic hybrid porous material, there is proposed an organo-inorganic hybrid porous material obtained by hybridizing an inorganic material such as ceramics, metal, and glass with polyimide (see, e.g., JP-A No. 2005-146243). This proposed technique produces the organo-inorganic hybrid porous material by using solvent extraction method.

There is also proposed an organo-inorganic hybrid porous material that contains bacterial cellulose and a bond reinforcing agent, and in which a film of the bacterial cellulose is formed to cover the pores (see, e.g., JP-A No. 2009-62460). This proposed technique produces the organo-inorganic hybrid porous material by using freezing drying method.

However, these proposed techniques are problematic in that it is necessary to dispose of a large amount of a solvent, it takes a long time to make the product porous, etc.

In regard to the problems of the conventional techniques described above, the porous material producing method of the present invention is free from disposal of a solvent used for the production, can produce the product by taking a short time to make the product porous, and can produce an organo-inorganic hybrid porous material, provided that an inorganic material is used as a raw material.

### (Shaped Product and Method for Producing the Same)

A shaped product according to the present invention contains the porous material of the present invention, and further contains other components according to necessity. The shaped product may be the porous material itself. The method for producing the shaped product is not particularly limited and may be appropriately selected according to the purpose. For example, it includes a polymerizing step, a porosity imparting step, and a shaping step, and further includes other steps according to necessity.

### <Polymerizing Step>

The polymerizing step may be the polymerizing step explained in the description for the porous material producing method of the present invention.

### <Porosity Imparting Step>

The porosity imparting step may be the porosity imparting step explained in the description for the porous material producing method of the present invention.

### <Shaping Step>

The shaping step is not particularly limited and may be appropriately selected according to the purpose, as long as it is a step of shaping the porous material. Examples thereof include a step of shaping the porous material into a particle state, a step of shaping the porous material into a film, a step of shaping the porous material into a sheet, a step of shaping the porous material into a fiber, and a step of shaping the porous material with a predetermined die.

It is preferable to perform the porosity imparting step and the shaping step simultaneously. That is, a step of making the resin obtained in the polymerizing step porous by rapidly expanding the compressive fluid contained in the resin while also shaping the resin is preferable, because such a step will make the shaping process easier. The resin containing the compressive fluid is in a low viscosity state because of the characteristic of the compressive fluid. Therefore, the shaping process will be facilitated by shaping the resin while rapidly expanding the compressive fluid contained in the resin at the same time.

The rate of the rapid expansion is not particularly limited and may be appropriately selected according to the purpose as long as it is such a rate of expanding the compressive fluid at which the resin that contains the compressive fluid will be porous when the compressive fluid is expanded. However, it is preferable to reduce pressure at a rate of 10 MPa/s or higher.

<<Step of Shaping into Particle State>>

The step of shaping the porous material into a particle state is not particularly limited and may be appropriately selected according to the purpose. Examples thereof include a step of pulverizing the porous material. The method for pulverizing the porous material is not particularly limited and may be appropriately selected according to the purpose. The particle diameter of the particles is not particularly limited and may be appropriately selected according to the purpose. However, it is preferably from 1 μm to 50 μm.

<<Step of Shaping into Film>>

The step of shaping the porous material into a film is not particularly limited and may be appropriately selected according to the purpose. Examples thereof include stretching. Examples of the method for stretching include uniaxial stretching, and simultaneous or sequential biaxial stretching (e.g., a tubular method and a tenter method). Here, a film means a filter having an average thickness of less than 250 μm.

By such stretching, various stretched films such as an stretched sheet, a flat yarn, a stretched tape, a band, a tape with lines, and a split yarn can be obtained. The average thickness of a stretched film is arbitrary according to the application of the stretched film. However, it is preferably 5 μm or greater but less than 250 μm.

<<Step of Shaping into Sheet>>

The step of shaping the porous material into a sheet is not particularly limited and may be appropriately selected according to the purpose. Examples thereof include a T-die method, an inflation method, and a calender method. The shaping conditions for shaping the porous material into a sheet are not particularly limited and may be appropriately selected according to the purpose. For example, when the T-die method is employed to shape the porous material which contains a polylactic acid, it is possible to shape the porous material into a sheet by extruding the porous material from a T-die with an extrusion molder fitted with the T-die at the outlet thereof while heating the porous material to preferably from 150° C. to 250° C.

<<Step of Shaping into Fiber>>

The method of shaping the porous material into a fiber is not particularly limited and may be appropriately selected according to the purpose. Examples thereof include melt spinning.

<<Step of Shaping with Predetermined Die>>

The step of shaping the porous material with a predetermined die is not particularly limited and may be appropriately selected according to the purpose. Examples thereof include injection molding, vacuum molding, compressed air molding, vacuum compressed air molding, and press molding. The shaping conditions for shaping the porous material with a predetermined die are not particularly limited and may be appropriately selected according to the purpose. For example, when injection molding is employed, it is possible to mold the porous material by heating it to from 150° C. to 250° C., injecting it into a die, and setting the temperature of the die to from 20° C. to 80° C.

In the step of shaping the porous material into a film, the step of shaping it into a sheet, and the step of shaping it with a predetermined die, it is preferable to shape the resin which contains the compressive fluid while rapidly expanding the compressive fluid, because this will make the shaping process easier. The resin containing the compressive fluid is in a low viscosity state because of the characteristics of the compressive fluid. Therefore, by shaping the resin while rapidly expanding the compressive fluid contained in the resin, it is possible to shape the resin by gradually changing it from a low viscosity state to a high viscosity state. This will eliminate the necessity for heating in the step of shaping the material into a film, the step of shaping the material into a sheet, and the step of shaping the material with a predetermined die, which makes the shaping process easier.

### (Serial Producing Apparatus of Porous Material)

A serial producing apparatus of the porous material of the present invention includes at least a first supply unit, a second supply unit, a contact region, a reacting region, a supply port, and a discharge port, and further includes other members according to necessity.

The first supply unit supplies raw materials including the monomer to the contact region.

The second supply unit supplies the compressive fluid to the contact region.

The contact region brings the monomer and the compressive fluid into contact with each other.

The reacting region progresses polymerization reaction of the monomer in the presence of the compressive fluid.

The supply port supplies a second compressive fluid to the resin obtained in the reacting region.

The discharge port includes a discharge port from which the resin obtained in the reacting region is discharged by being made porous.

Here, a producing apparatus for producing the porous material of the present invention will be explained with reference to the drawings.

### First Embodiment

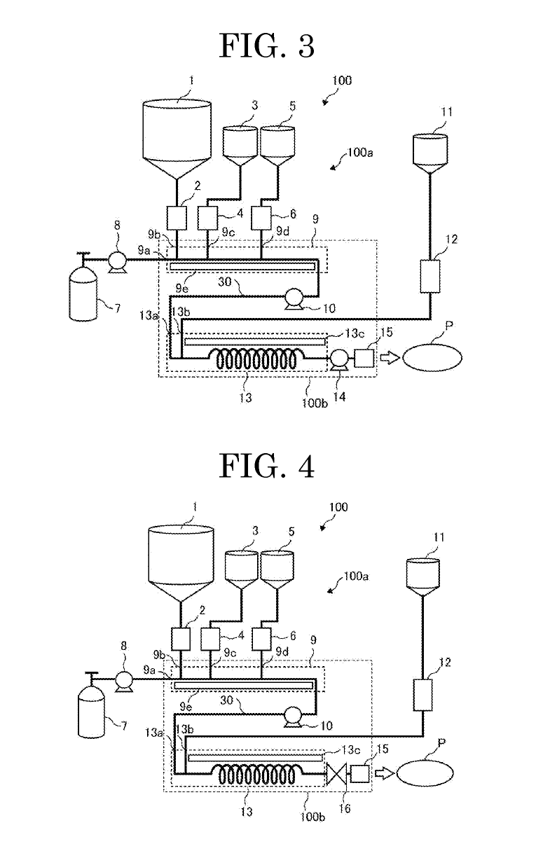

FIG. 3 and FIG. 4 are system line diagrams showing an example of the polymerizing step. In the system line diagram shown in FIG. 3, a polymerization reaction apparatus 100 a supply unit 100a configured to supply the ring-opening-polymerizable monomer, the filler material (e.g., an inorganic material), and the compressive fluid, and a polymerization reaction apparatus body 100b as an example polymer producing apparatus configured to polymerize the ring-opening-polymerizable monomer supplied by the supply unit 100a. The supply unit 100a includes tanks (1, 3, 5, 7, 11), gauge feeders (2, 4), and gauge pumps (6, 8, 12). The polymerization reaction apparatus body 100b includes a contact region 9 provided at one end portion of the polymerization reaction apparatus body 100b, a liquid conveying pump 10, a reacting region 13, a gauge pump 14, and a porosity imparting unit 15 provided at the other end portion of the polymerization reaction apparatus body 100b.

The tank 1 and the gauge feeder 2 constitute the first supply unit. The tank 7 and the gauge pump 8 constitute the second supply unit.

The tank 1 of the supply unit 100a stores a ring-opening-polymerizable monomer. The ring-opening-polymerizable monomer stored therein may be a powder state or a liquid state. The tank 3 stores a solid (powder or granular) one of the initiator and the additive. The tank 5 stores a liquid one of the filler material (e.g., an inorganic material), the initiator, and the additive. The tank 7 stores the compressive fluid. The tank 7 may store a gaseous body (gas) or a solid that turns to the compressive fluid through the process of being supplied to the contact region 9 or that turns to the compressive fluid by being heated or pressurized in the contact region 9. In this case, the gaseous body or the solid stored in the tank 7 becomes the state of (1), (2), or (3) in the phase diagram of FIG. 2 in the contact region 9 by being heated or pressurized.

The gauge feeder 2 weighs the ring-opening-polymerizable monomer stored in the tank 1 and supplies it to the contact region 9 serially. The gauge feeder 4 weighs the solid stored in the tank 3 and supplies it to the contact region 9 serially. The gauge pump 6 weighs the liquid stored in the tank 5 and supplies it to the contact region 9 serially. The gauge pump 8 supplies the compressive fluid stored in the tank 7 to the contact region 9 serially at a constant pressure at a constant flow rate. In the present embodiment, to supply serially is a notion opposed to supplying batch wise, and means to supply the materials such that a resin porous material that contains a polymer to be obtained by ring-opening polymerizing the ring-opening-polymerizable monomer can be obtained serially. That is, as long as the resin porous material that contains the polymer to be obtained by ring-opening polymerizing the ring-opening-polymerizable monomer can be obtained serially, the respective materials may be supplied intermissively or intermittently. When both of the initiator and the additive are solid, the polymerization reaction apparatus 100 needs not include the tank 5 and the gauge pump 6. Likewise, when both of the initiator and the additive are liquid, the polymerization reaction apparatus 100 needs not include the tank 3 and the gauge feeder 4.

In the present embodiment, the polymerization reaction apparatus body 100b is a tubular apparatus that includes at one end portion thereof, a monomer inlet through which the ring-opening-polymerizable monomer is introduced, and at the other end portion thereof, an outlet configured to make the resin that contains the polymer obtained by polymerizing the ring-opening-polymerizable monomer porous and discharge it as a resin porous material. The polymerization reaction apparatus body 100b also includes at the one end portion thereof, a compressive fluid inlet through which the compressive fluid is introduced, and at a portion between the one end portion and the other end portion, a catalyst inlet through which a catalyst is introduced. The respective devices of the polymerization reaction apparatus body 100b are connected as shown in FIG. 3 via a pressure-tight tube 30 through which the raw materials, the compressive fluid, or the produced polymer is conveyed. The respective devices of the contact region 9, the liquid conveying pump 10, and the reacting region 13 of the polymerization reaction apparatus include a tubular member through which the raw materials, etc. are passed.

The contact region 9 of the polymerization reaction apparatus body 100b is constituted by a pressure-tight apparatus or tube in which to bring the raw materials such as the ring-opening-polymerizable monomer, the filler material (e.g., an inorganic material), the initiator, and additive supplied from the tanks (1, 3, 5) into contact with the compressive fluid supplied from the tank 7 serially to mix the raw materials (for example, to melt or dissolve the ring-opening-polymerizable monomer and the initiator). In the present embodiment, to be melted means that the raw materials or the produced polymer are/is swollen upon contact with the compressive fluid to be thereby plasticized or liquefied. To be dissolved means that the raw materials flux in the compressive fluid. A fluid phase is formed when the ring-opening-polymerizable monomer is dissolved, and a melt phase is formed when it is melted. In order for the reaction to progress uniformly, it is preferable that either a melt phase or a fluid phase be formed. Further, because it is preferable that the reaction progress with the ratio of the raw materials being higher than the ratio of the compressive fluid, it is preferable to melt the ring-opening-polymerizable monomer. In the present embodiment, by supplying the raw materials and the compressive fluid serially, it is possible to bring the raw materials such as the ring-opening-polymerizable monomer and the compressive fluid into contact with each other serially in the contact region 9 at a constant concentration ratio. This allows the raw materials to be mixed efficiently (for example, allows the ring-opening-polymerizable monomer and the initiator to be melted or dissolved efficiently).

The contact region 9 may be constituted by either a tank-shaped apparatus or a tubular apparatus. However, it is preferably constituted by a tubular apparatus, from one end of which the raw materials are supplied, and from the other end of which a mixture such as a melt phase or a fluid phase is taken out. Further, the contact region 9 may include a stirrer configured to stir the raw materials, the compressive fluid, etc. When the contact region 9 includes a stirrer, preferable examples of the stirrer include a uniaxial screw, biaxial screws meshing with each other, a biaxial mixer including multiple stirring elements meshing or overlapping with each other, a kneader including helical stirring elements meshing with each other, and a static mixer. Particularly, biaxial or multiaxial stirrers meshing with each other are preferable because few deposits of the reaction product will occur in these stirrers and containers, and these stirrers have a self-cleaning functionality. When the contact region 9 does not include a stirrer, it is preferable that the contact region 9 be constituted by part of the pressure-tight tube 30. When the contact region 9 is constituted by the tube 30, it is preferable that the ring-opening-polymerizable monomer to be supplied to the contact region 9 be liquefied in advance, in order to ensure that the raw materials will be mixed in the contact region 9 infallibly.

The contact region 9 is provided with an inlet 9a as an example compressive fluid inlet through which the compressive fluid supplied from the tank 7 by the gauge pump 8 is introduced, an inlet 9b as an example monomer inlet through which the ring-opening-polymerizable monomer supplied from the tank 1 by the gauge feeder 2 is introduced, an inlet 9c through which powder supplied from the tank 3 by the gauge feeder 4 is introduced, and an inlet 9d through which the liquid supplied from the tank 5 by the gauge pump 6 is introduced. In the present embodiment, the inlets (9a, 9b, 9c, 9d) are each constituted by a joint that connects a tubular member such as a cylinder or part of the tube 30 through which the raw materials, etc. are supplied in the contact region 9 to a corresponding tube from which each raw material or the compressive fluid is conveyed. The joint is not particularly limited, and examples thereof include publicly-known joints such as a reducer, a coupling, Y, T, and an outlet. The contact region 9 also includes a heater 9e for heating the raw materials and the compressive fluid supplied thereto.

The liquid conveying pump 10 conveys a mixture such as a melt phase or a fluid phase formed in the contact region 9 to the reacting region 13. The tank 11 stores a catalyst. The gauge pump 12 weighs the catalyst stored in the tank 11 and supplies it to the reacting region 13.

The reacting region 13 is constituted by a pressure-tight apparatus or tube in which to mix the raw materials conveyed by the liquid conveying pump 10 with the catalyst supplied by the gauge pump 12 to thereby ring-opening polymerize the ring-opening-polymerizable monomer. The reacting region 13 may be constituted by a tank-shaped apparatus or a tubular apparatus. However, it is preferably constituted by a tubular apparatus because one has little dead space. The reacting region 13 may also include a stirrer configured to stir the raw materials, the compressive fluid, etc. As the stirrer of the reacting region 13, screws meshing with each other, a 2-flight (oval) or 3-flight (triangular) stirring element, and a biaxial or multiaxial stirrer including a stirring blade having a disk shape or a multi-leaf shape (e.g., a clover shape) are preferable in terms of self-cleaning ability. When the raw materials including the catalyst are mixed well in advance, a static mixer configured to divide and combine (converge) flows through multi-stages in a guide device may also be used as the stirrer. Examples of the static mixer include those disclosed in Japanese Patent Application Publications (JP-B) Nos. 47-15526, 47-15527, 47-15528, and 47-15533 (multi-stage mixing type), one disclosed in JP-A No. 47-33166 (Kenics type), and a mixer similar to those listed above including no movable member. When the reacting region 13 does not include a stirrer, the reacting region 13 is constituted by part of the pressure-tight tube 30. In this case, the shape of the tube is not particularly limited and may be appropriately selected according to the purpose, but a preferable shape is a helical shape, in order to reduce the size of the apparatus.

The reacting region 13 is provided with an inlet 13a through which the raw materials mixed in the contact region 9 are introduced, and an inlet 13b as an example catalyst inlet through which the catalyst supplied from the tank 11 by the gauge pump 12 is introduced. In the present embodiment, the inlets (13a, 13b) are each constituted by a joint that connects a tubular member such as a cylinder or part of the tube 30 through which the raw materials, etc. are passed in the reacting region 13 to each tube from which each raw material or the compressive fluid is supplied. The joint is not particularly limited, and examples thereof include publicly-known joints such as a reducer, a coupling, Y, T, and an outlet. The reacting region 13 may also be provided with a gas outlet through which an evaporant is removed. The reacting region 13 also includes a heater 13c for heating the raw materials conveyed therein.

FIG. 3 shows an example in which there is one reacting region 13. However, the polymerization reaction apparatus 100 may include 2 or more reacting regions 13. When there are a plurality of reacting regions 13, the reacting regions 13 may have the same reaction (polymerization) conditions such as temperature, catalyst concentration, pressure, average retention time, and stirring speed. However, it is preferable to select optimum conditions separately in accordance with the respective degrees of progress of the polymerization. It is not advisable to couple too many reacting regions 13 multi-stages, because this would increase the reaction time or complicate the apparatus. The number of stages is preferably from 1 to 4, and particularly preferably from 1 to 3.

Generally, when polymerization is performed with only one reacting region, the degree of polymerization of the polymer to be obtained from the ring-opening polymerization of the ring-opening-polymerizable monomer and the amount of residual monomer tend to be unstable and fluctuate, which is considered unsuitable for industrial production. This is considered due to instability attributed to mixed presence of the raw materials having a melt viscosity of from several poise to several ten poise and the polymer resulting from the polymerization having a melt viscosity of several thousand poise. As compared with this, in the present embodiment, the raw materials and the produced polymer melt (liquefy), which makes it possible to reduce the viscosity difference in the reacting region 13 (also referred to as a polymerization system). Therefore, it is possible to produce a polymer stably with a less number of stages than in a conventional polymerization reaction apparatus.

The gauge pump 14 discharges the resin that contains the polymer resulting from polymerization in the reacting region 13 to the outside through the porosity imparting unit 15 as a resin porous material P. At this time, the resin is made porous and becomes a resin porous material, by being discharged while the compressive fluid is rapidly expanded. It is preferable to additionally feed the compressive fluid (the second compressive fluid) to the porosity imparting unit 15 through an additional feeding port (unillustrated).

By additionally feeding the compressive fluid (the second compressive fluid), it is possible to produce a porous material having a high porosity and a small pore wall thickness.

It is also possible to discharge the resin from inside the reacting region 13 as a resin porous material P without the gauge pump 14, by utilizing the pressure difference between the inside and the outside of the reacting region 13. In this case, in order to adjust the pressure inside the reacting region 13 and the amount of the resin porous material P to be discharged, it is also possible to use a pressure adjusting valve 16 as shown in FIG. 4, instead of the gauge pump 14.

The porosity imparting unit 15 preferably includes a stirrer in order to mix the additionally fed compressive fluid (the second compressive fluid) with the resin. As the mixer, screws meshing with each other, a 2-flight (oval) or 3-flight (triangular) stirring element, and a biaxial or multiaxial stirrer including a stirring blade having a disk shape or a multi-leaf shape (e.g., a clover shape) are preferable in terms of self-cleaning ability. A static mixer configured to divide and combine (converge) flows through multi-stages in a guide device may also be used as the stirrer. Examples of the static mixer include those disclosed in JP-B Nos. 47-15526, 47-15527, 47-15528, and 47-15533 (multi-stage mixing type), one disclosed in JP-A No. 47-33166 (Kenics type), and a mixer similar to those listed above including no movable member.

### <Polymerizing Step>

Next, a step of polymerizing a ring-opening-polymerizable monomer with the polymerization reaction apparatus 100 will be explained. In the present embodiment, the ring-opening-polymerizable monomer, the compressive fluid, and according to necessity, a filler material (e.g., an inorganic material) are supplied serially and brought into contact with each other, to ring-opening polymerize the ring-opening-polymerizable monomer to obtain a resin that contains a resulting polymer serially. First, the gauge feeders (2, 4), the gauge pump 6, and the gauge pump 8 are actuated to supply the ring-opening-polymerizable monomer, the initiator, the additive, and the compressive fluid in the tanks (1, 3, 5, 7) serially. Therefore, the raw materials and the compressive fluid are introduced serially into the tube in the contact region 9 through the inlets (9a, 9b, 9c, 9d). Weighing of a solid (powder or granular) raw material might be less precise than weighing of a liquid raw material. In this case, a solid raw material may be melted in advance in order to be stored in the tank 5 and introduced into the tube in the contact region 9 by the gauge pump 6 in its liquid state. The order to actuate the gauge feeders (2, 4), the gauge pump 6, and the gauge pump 8 is not particularly limited. However, if the raw materials in the initial stage are supplied into the reacting region 13 without contacting the compressive fluid, the raw materials might be solidified due to a temperature drop. Therefore, it is preferable to actuate the gauge pump 8 first.

The feeding rates of the raw materials by the gauge feeders (2, 4) and the gauge pump 6 are adjusted to a constant ratio among them, based on a predetermined quantitative ratio among the ring-opening-polymerizable monomer, the filler material (e.g., an inorganic material), the initiator, and the additive. The total of the masses of the raw materials supplied per unit time by the gauge feeders (2, 4) and the gauge pump 6 (the total being the raw material feeding rate (g/min)) is adjusted based on desired physical properties of the polymer, the reaction time, etc. Likewise, the mass of the compressive fluid (compressive fluid feeding rate (g/min)) supplied per unit time by the gauge pump 8 is adjusted based on desired physical properties of the polymer, the reaction time, etc. The ratio between the compressive fluid feeding rate and the raw material feeding rate (raw material feeding rate/compressive fluid feeding rate, referred to as feeding ratio) is preferably 1 or greater, more preferably 3 or greater, even more preferably 5 or greater, and particularly preferably 10 or greater. The upper limit of the feeding ratio is preferably 1,000 or less, more preferably 100 or less, and particularly preferably 50 or less.

With the feeding ratio of 1 or greater, when the raw materials and the compressive fluid are conveyed to the reacting region 13, the reaction will progress in the state where the concentration of the raw materials and the produced polymer (so-called solid content concentration) is high. The solid content concentration in the polymerization system in this case is greatly different from a solid content concentration in a polymerization system in which polymerization is performed by dissolving a smaller amount of ring-opening-polymerizable monomer in a much greater amount of compressive fluid according to a conventional producing method. The producing method of the present embodiment is characterized in that the polymerization reaction progresses efficiently and stably even in a polymerization system having a high solid content concentration. In the present embodiment, the feeding ratio may be less than 1. Even in this case, the polymer to be obtained will not have any problem in the quality, but an economical efficiency will be less. When the feeding ratio is greater than 1,000, the capacity of the compressive fluid to dissolve the ring-opening-polymerizable monomer might be insufficient, to make it impossible to progress the intended reaction uniformly.

Since the raw materials and the compressive fluid are introduced into the tube in the contact region 9 serially, they contact each other serially. Therefore, the raw materials such as the ring-opening-polymerizable monomer, the filler material (e.g., an inorganic material), the initiator, and the additive mix with one another in the contact region 9. When the contact region 9 includes a stirrer, the raw materials and the compressive fluid may be stirred. In order for the introduced compressive fluid to be prevented from turning to a gas, the temperature and pressure in the tube in the reacting region 13 are controlled to a temperature and pressure that are equal to or greater than at least the triple point of the compressive fluid. This control is performed by adjusting the power of the heater 9e in the contact region 9 or the feeding rate of the compressive fluid. In the present embodiment, the temperature when melting the ring-opening-polymerizable monomer may be a temperature that is equal to or lower than the melting point of the ring-opening-polymerizable monomer at normal pressures. This is considered possible because the contact region 9 internally becomes a high-pressure state in the presence of the compressive fluid to thereby lower the melting point of the ring-opening-polymerizable monomer to below the melting point thereof at normal pressures. Hence, even when the amount of the compressive fluid relative to the ring-opening-polymerizable monomer is small, the ring-opening-polymerizable monomer melts in the contact region 9.

In order for the raw materials to mix efficiently, it is possible to adjust the timing to apply heat or stirring to the raw materials and the compressive fluid in the contact region 9. In this case, heat or stirring may be applied after the raw materials and the compressive fluid are brought into contact with each other, or heat or stirring may be applied while the raw materials and the compressive fluid are brought into contact with each other. In order for them to mix more infallibly, it may be after heat equal to or higher than the melting point of the ring-opening-polymerizable monomer is applied to the ring-opening-polymerizable monomer that the ring-opening-polymerizable monomer and the compressive fluid are brought into contact with each other. When the contact region 9 is, for example, a biaxial mixer, each of these schemes is realized by appropriately setting the arrangement of the screws, the positions of the inlets (9a, 9b, 9c, 9d), and the temperature of the heater 9e.

In the present embodiment, the filler material (e.g., an inorganic material) and the additive are supplied to the contact region 9 separately from the ring-opening-polymerizable monomer. However, the filler material (e.g., an inorganic material) and the additive may be supplied together with the ring-opening-polymerizable monomer. The additive may be supplied after the polymerization reaction. In this case, it is possible to take out the resin porous material that contains the obtained polymer from the reacting region 13, and then add the additive by kneading.

The raw materials mixed in the contact region 9 are conveyed by the liquid conveying pump 10 to be supplied into the reacting region 13 through the inlet 13a. Meanwhile, the catalyst in the tank 11 is weighed by the gauge pump 12 and supplied into the reacting region 13 in a predetermined amount through the inlet 13b. As the catalyst can work at room temperature, in the present embodiment, it is preferable to add the catalyst after the raw materials are mixed with the compressive fluid. The reaction often progresses uniformly, if the catalyst is added to the polymerization system in the reacting region 13 in which the ring-opening-polymerizable monomer, the initiator, etc. have been dissolved or melted sufficiently by the compressive fluid. However, depending on the ring-opening-polymerizable monomer, the initiator, etc., the catalyst may be added before the ring-opening-polymerizable monomer, the initiator, etc. are brought into contact with the compressive fluid.

The raw materials conveyed by the liquid conveying pump 10 and the catalyst supplied by the gauge pump 12 are stirred sufficiently, if necessary by the stirrer in the reacting region 13, or heated to a predetermined temperature by the heater 13c while being conveyed. As a result, the ring-opening-polymerizable monomer is ring-opening polymerized in the reacting region 13 in the presence of the catalyst (polymerizing step).

The lower limit of the temperature when ring-opening polymerizing the ring-opening-polymerizable monomer (polymerization reaction temperature) is not particularly limited and may be appropriately selected according to the purpose. However, it is preferably 40° C., more preferably 50° C., and particularly preferably 60° C. When the polymerization reaction temperature is lower than 40° C., some kinds of ring-opening-polymerizable monomers might take a longer time to be melted by the compressive fluid or might result in being insufficiently melted, or the activity of the catalyst might be weakened. This tends to slow down the reaction speed of the polymerization, and makes it impossible to progress the polymerization reaction quantitatively.

The upper limit of the polymerization reaction temperature is not particularly limited, but is higher one of 150° C. and a temperature higher than the melting point of the ring-opening-polymerizable monomer by 30° C. The upper limit of the polymerization reaction temperature is preferably higher one of 130° C. and the melting point of the ring-opening-polymerizable monomer. The upper limit of the polymerization reaction temperature is more preferably higher one of 80° C. and a temperature lower than the melting point of the ring-opening-polymerizable monomer by 20° C. When the polymerization reaction temperature is higher than the temperature higher than the melting point of the ring-opening-polymerizable monomer by 30° C., it becomes likely that depolymerization reaction, which is a reverse reaction of the ring-opening polymerization, will occur in equilibrium, which makes it harder for the polymerization reaction to progress quantitatively. When a low melting point ring-opening-polymerizable monomer such as a ring-opening-polymerizable monomer that is liquid at room temperature is used, the polymerization reaction temperature may be set to a temperature higher than the melting point by 30° C. in order to enhance the activity of the catalyst. Also in this case, it is preferable to set the polymerization reaction temperature to 150° C. or lower. The polymerization reaction temperature is controlled by the heater 13c provided in the reacting region 13 or by heating or the like from outside of the reacting region 13.

A conventional polymer producing method using supercritical carbon dioxide has polymerized a ring-opening-polymerizable monomer by using a large amount of supercritical carbon dioxide, because the lytic potential of supercritical carbon dioxide to the polymer is low. The polymerization method of the present embodiment can ring-opening polymerize a ring-opening-polymerizable monomer at a high concentration that has not been achieved by conventional polymer producing methods using a compressive fluid. In this case, the reacting region 13 internally becomes a high-pressure state in the presence of the compressive fluid, to thereby lower the glass transition temperature (Tg) of the produced polymer. This will lower the viscosity of the produced polymer to allow the ring-opening polymerization reaction to progress uniformly even in the state where the concentration of the polymer has become high.

In the present embodiment, the polymerization reaction time (average retention time in the reacting region 13) is set according to the target molecular weight. However, generally, it is preferably 1 hour or shorter, more preferably 45 minutes or shorter, and still more preferably 30 minutes or shorter. According to the producing method of the present embodiment, the polymerization reaction time may be set to 20 minutes or shorter. This is an unprecedented short time for polymerization of a ring-opening-polymerizable monomer in a compressive fluid.

The pressure during polymerization, i.e., the pressure of the compressive fluid may be a pressure at which the compressive fluid supplied from the tank 7 turns to a liquefied gas ((2) in the phase diagram of FIG. 2) or a high-pressure gas ((3) in the phase diagram of FIG. 2). However, it is preferably a pressure at which the compressive fluid turns to a supercritical fluid ((1) in the phase diagram of FIG. 2). By turning the compressive fluid to a supercritical fluid state, which will promote melting of the ring-opening-polymerizable monomer, it is possible to progress the polymerization reaction uniformly and quantitatively. When carbon dioxide is used as the compressive fluid, the pressure thereof is 3.7 MPa or higher, preferably 5 MPa or higher, and more preferably the critical pressure thereof of 7.4 MPa or higher, in consideration of reaction efficiency, polymer conversion rate, etc. Further, when carbon dioxide is used as the compressive fluid, the temperature thereof is preferably 25° C. or higher by the same token.

The amount of moisture in the reacting region 13 is not particularly limited and may be appropriately selected according to the purpose. However, it is preferably 4 mol % or less, more preferably 1 mol % or less, and particularly preferably 0.5 mol % or less relative to the ring-opening-polymerizable monomer. When the amount of moisture is greater than 4 mol %, moisture itself starts to contribute as the initiator, which may make it difficult to control the molecular weight. In order to control the amount of moisture in the polymerization system, it is possible to add an operation of removing moisture contained in the ring-opening-polymerizable monomer and the other raw materials as a pre-treatment, if necessary.

The resin that has completed the polymerization reaction in the reacting region 13 (an aliphatic polyester resin, an aliphatic polycarbonate resin, or both thereof) is conveyed to the porosity imparting unit 15 by the gauge pump 14, and discharged to the outside as a resin porous material P with the compressive fluid additionally fed to the porosity imparting unit 15 and rapidly expanded.

It is preferable that the additionally fed compressive fluid and the polymerized resin be mixed in the porosity imparting unit 15.

The catalyst remained in the resin porous material that contains the polymer obtained in the present embodiment is removed according to necessity. The removing method is not particularly limited and may be appropriately selected according to the purpose. Examples thereof include distillation at a reduced pressure when the target is a compound having a boiling point, a method of extracting and removing the catalyst by using as an entrainer a substance that can dissolve the catalyst, and a method of adsorbing and removing the catalyst with a column. In this case, the scheme for removing the catalyst may be a batch type for removing it after the organo-inorganic hybrid porous material that contains the polymer is taken out from the reacting region 13, or may be a serial type for removing it without taking it out. When distilling the catalyst at a reduced pressure, the pressure reducing condition is set based on the boiling point of the catalyst. For example, the temperature when the pressure is reduced is from 100° C. to 120° C., which means that it is possible to remove the catalyst at a temperature that is lower than the temperature at which the polymer is depolymerized. When an organic solvent is used for this extraction operation, it may be necessary to perform a step of removing the organic solvent after the catalyst is extracted. Therefore, also in this extraction operation, it is preferable to use the compressive fluid as the solvent. For such an extraction operation, it is possible to use publicly known techniques for extraction of aroma chemicals.

### Second Embodiment

### Applied Example

Next, a second embodiment, as an applied example of the first embodiment will be explained. In the producing method of the first embodiment, there is almost no residual monomer and the reaction (ring-opening polymerization of the ring-opening-polymerizable monomer) progresses quantitatively. Based on this, the first method of the second embodiment will add a further resin into a resin by using the resin produced by the producing method of the first embodiment, and by appropriately setting the timings to add 1 or more kinds of ring-opening-polymerizable monomers. The second method of the second embodiment will form a complex body of 2 or more kinds of resins by using 2 or more kinds of resins including the resin produced by the producing method of the first embodiment and by serially mixing the 2 or more kinds of resins in the presence of the compressive fluid. In the present embodiment, a “resin complex body” means a copolymer that includes 2 or more kinds of resin segments obtained by polymerizing a monomer through a plurality of separate system lines, or a mixture of 2 or more kinds of resins obtained by polymerizing a monomer through a plurality of separate system lines. Two patterns for synthesizing a stereo complex, as an example of a complex body, will be explained below.

### <First Method and Apparatus>

The first method of the second embodiment is not particularly limited and may be appropriately selected according to the purpose. For example, it includes the polymerizing step described above (first polymerizing step), and a second polymerizing step of bringing a first polymer obtained by ring-opening polymerizing a first ring-opening-polymerizing monomer in the first polymerizing step and a second ring-opening-polymerizable monomer into contact with each other serially and polymerizing the first polymer with the second ring-opening-polymerizable monomer, and further includes other steps according to necessity. A resin complex body producing apparatus, which is a first apparatus of the second embodiment, includes the polymer producing apparatus described above and a second reacting region through which the compressive fluid is circulated. The second reacting region includes at an upstream side thereof, a second monomer inlet through which the second ring-opening-polymerizable monomer is introduced and an inlet through which a first resin discharged through the porosity imparting unit 15 of the polymer producing apparatus is introduced, at a downstream side of the second monomer inlet, a second catalyst inlet through which a second catalyst is introduced, and at a downstream side of the second catalyst inlet, an outlet through which a resin obtained by polymerizing the first polymer with the second ring-opening-polymerizable monomer is discharged, and further includes other members according to necessity. The producing method may be preferably performed by the resin complex body producing apparatus. The resin complex body producing apparatus is preferably a resin complex body serial producing apparatus having a tubular shape, in which: the second reacting region is a tubular reacting region that includes at one end portion thereof (the upstream side), the second monomer inlet through which the second ring-opening-polymerizable monomer is introduced and the inlet through which the first resin discharged through the porosity imparting unit 15 of the polymer producing apparatus described above is introduced, at the other end portion thereof, an outlet through which a resin complex body obtained by polymerizing the first resin with the second ring-opening-polymerizable monomer is discharged, and at a portion between the one end portion and the other end portion, the second catalyst inlet through which the second catalyst is introduced; the polymer producing apparatus described above is a polymer serial producing apparatus having a tubular shape; and the inlet (the inlet through which the first resin is introduced) is connected with the porosity imparting unit 15 of the polymer producing apparatus described above. The first ring-opening-polymerizable monomer and the second ring-opening-polymerizable monomer are not particularly limited and may be selected according to the purpose from those listed as the ring-opening-polymerizable monomer. They may be different kinds of ring-opening-polymerizable monomers from each other, or may be the same kind. For example, it is also possible to obtain a stereo complex body by using monomers that are each other's enantiomers. The first catalyst and the second catalyst are not particularly limited, may be selected according to the purpose from those listed as the catalyst, and may be the same as or different from each other.

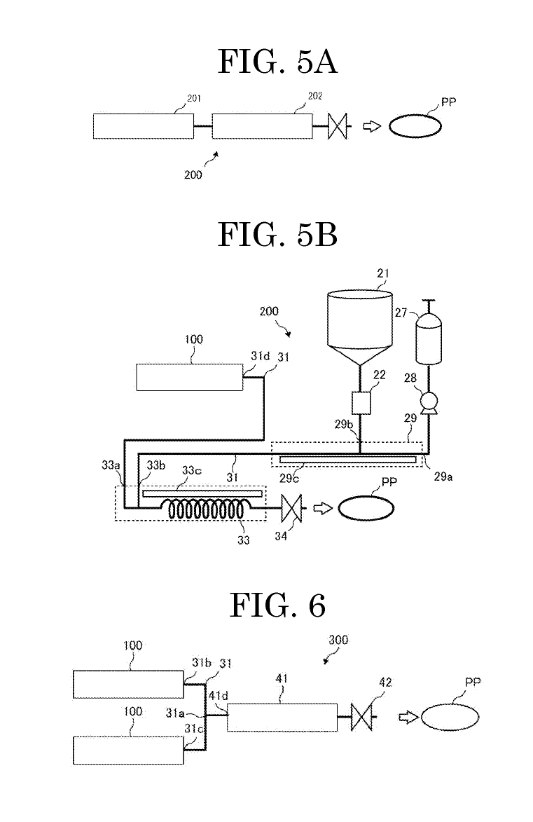

First, the first method will be explained with reference to FIG. 5A and FIG. 5B. FIG. 5A and FIG. 5B are exemplary diagrams showing a complex body producing system used in the first method. The first method includes a mixing step of mixing the resin obtained by the producing method of the first embodiment serially in the presence of a compressive fluid. Specifically, a resin is produced by the producing method of the first embodiment in a system line 1 (indicated by a reference sign 201 in FIG. 5A) of a producing system 200 of FIG. 5A, and the produced resin P′ is brought into contact with the second ring-opening-polymerizable monomer newly introduced in a system line 2 (indicated by a reference sign 202 in FIG. 5A) in order to mix them serially in the presence of the compressive fluid, to thereby produce a resin that contains a resin complex body and obtain a resin porous material PP by making it porous. It is also possible to obtain a resin porous material PP including 3 or more kinds of segments by repeating the same system line as the system line 2 of the producing system 200 of FIG. 5A in series.

Next, a specific example of the producing system 200 will be explained with reference to FIG. 5B. The producing system 200 includes the same polymerization reaction apparatus 100 as that used in the first embodiment, tanks (21, 27), a gauge feeder 22, a gauge pump 28, a contact region 29, a reacting region 33, and a pressure adjusting valve 34.

In the producing system 200, the reacting region 33 is constituted by a tube or a tubular apparatus that includes at one end portion thereof, an inlet 33a through which the first resin is introduced, and at the other end portion thereof, an outlet through which the resin porous material obtained by making porous the resin that contains the resin complex body obtained by mixing a plurality of resins is discharged. The inlet 33a of the reacting region 33 is connected to the outlet of the polymerization reaction apparatus 100 through a pressure-tight tube 31. Here, an outlet 31d of the polymerization reaction apparatus 100 means the leading end of the tube 30 or cylinder in the reacting region 13, or the outlet of the gauge pump 14 (FIG. 3) or of the pressure adjusting valve 16 (FIG. 4). In any case, the resin P′ produced by each polymerization reaction apparatus 100 can be supplied to the reacting region 33 without being returned to normal pressures.

The tank 21 stores the second ring-opening-polymerizable monomer. In the first method, the second ring-opening-polymerizable monomer is an enantiomer of the ring-opening-polymerizable monomer stored in the tank 1. The tank 27 stores a compressive fluid. The compressive fluid stored in the tank 27 is not particularly limited, but is preferably the same kind as the compressive fluid stored in the tank 7 in order for the polymerization reaction to progress uniformly. The tank 27 may store a gaseous body (gas) or a solid that turns to a compressive fluid through the process of being supplied to the contact region 29 or that turns to a compressive fluid by being heated or pressurized in the contact region 29. In this case, the gaseous body or the solid stored in the tank 27 becomes the state of (1), (2), or (3) in the phase diagram of FIG. 2 in the contact region 29 by being heated or pressurized.

The gauge feeder 22 weighs the second ring-opening-polymerizable monomer stored in the tank 21 and supplies it to the contact region 29 serially. The gauge pump 28 supplies the compressive fluid stored in the tank 27 to the contact region 29 serially at a constant pressure at a constant flow rate.

The contact region 29 is constituted by a pressure-tight apparatus or tube in which to bring the second ring-opening-polymerizable monomer supplied from the tank 21 and the compressive fluid supplied from the tank 27 into contact with each other serially to dissolve or melt the raw materials. The container of the contact region 29 is provided with an inlet 29a through which the compressive fluid supplied from the tank 27 by the gauge pump 28 is introduced, and an inlet 29b through which the second ring-opening-polymerizable monomer supplied from the tank 21 by the gauge feeder 22 is introduced. The contact region 29 is provided with a heater 29c configured to heat the second ring-opening-polymerizable monomer and the compressive fluid supplied thereto. In the present embodiment, the same as the contact region 9 is used as the contact region 29.

The reacting region 33 is constituted by a pressure-tight apparatus or tube in which to polymerize the resin contained in the resin P′ produced by the polymerization reaction apparatus 100, with the second ring-opening-polymerizable monomer dissolved or melted in the compressive fluid in the contact region 29. The reacting region 33 is provided with an inlet 33a through which the organo-inorganic hybrid material P′ is introduced into the tube, and an inlet 33b through which the dissolved or melted second ring-opening-polymerizable monomer is introduced into the tube. The reacting region 33 is also provided with a heater 33c configured to heat resin P′ and the second ring-opening-polymerizable monomer conveyed. In the present embodiment, the same as the reacting region 13 is used as the reacting region 33. The pressure adjusting valve 34 as an example of the outlet discharges a resin porous material PP obtained by making the resin complex body produced in the reacting region 33 porous, to the outside of the reacting region 33 by utilizing the pressure difference between the inside and the outside of the reacting region 33.

In the first method, a ring-opening-polymerizable monomer (e.g., L-lactide) is polymerized in the reacting region 13, and after the reaction is completed quantitatively, an enantiomer ring-opening-polymerizable monomer (e.g., D-lactide) as an example of the second ring-opening-polymerizable monomer is added to the reacting region 33 to further progress the polymerization reaction. As a result, a stereo block copolymer is obtained. This method is very useful because racemization is very unlikely to occur and the product can be obtained through a one-stage reaction, since this method can progress the reaction at a temperature equal to or lower than the melting point of the ring-opening-polymerizable monomers with scarce residual monomers remaining.

### <Second Method and Apparatus>

A producing method, which is the second method of the second embodiment is not particularly limited and may be appropriately selected according to the purpose. It includes the polymerizing step described above, a mixing step of serially mixing the resin obtained in the polymerizing step with a polymer in the presence of a compressive fluid, and a porosity imparting step, and further includes other steps according to necessity. It is preferable that 2 or more kinds of resins in the resin porous material to be finally obtained include a first resin obtained by ring-opening polymerizing a first ring-opening-polymerizable monomer, and a second resin obtained by ring-opening polymerizing a second ring-opening-polymerizable monomer, and that the first ring-opening-polymerizable monomer and the second ring-opening-polymerizable monomer be each other's enantiomers. A complex body producing apparatus, which is a second apparatus of the second embodiment, includes 2 or more of the polymer producing apparatus described above, further includes a mixing vessel in which to mix the resins discharged from one outlet and any other outlet(s) of the 2 or more polymer producing apparatuses, and further includes other members according to necessity. Of the 2 or more polymer producing apparatuses, one polymer producing apparatus produces a resin, and any other polymer producing apparatus produces a polymer (a resin obtained by ring-opening polymerizing the ring-opening-polymerizable monomer in the presence of the compressive fluid). The producing method may be preferably performed by the complex body producing apparatus. The complex body producing apparatus is preferably a complex body serial producing apparatus having a tubular shape, in which: the 2 or more polymer producing apparatuses are each a polymer serial producing apparatus having a tubular shape; the mixing vessel is a tubular mixing vessel including 2 or more inlets at one end portion thereof (the upstream side) and a complex body outlet at the other end portion thereof; and the 2 or more inlets are connected to 2 or more outlets of the 2 or more polymer producing apparatuses, respectively.

Next, the second method will be explained with reference to FIG. 6. FIG. 6 is an exemplary diagram showing a complex body producing system used in the second method. The second method produces a resin that contains a resin complex body, by mixing resins that each include a polymer produced by the producing method of the first embodiment serially in the presence of a compressive fluid. Further, the second method produces a resin porous material PP by making the produced resin porous. The plurality of resins included in the resin porous material finally obtained are polymerization products obtained by separately polymerizing ring-opening-polymerizable monomers that are each other's enantiomers. A producing system 300 includes a plurality of polymerization reaction apparatuses 100, a mixing apparatus 41, and a pressure adjusting valve 42.

In the complex body producing system 300, an inlet 41d of the mixing apparatus 41 is connected to the outlets (31b, 31c) of the respective polymerization reaction apparatuses 100 through a pressure-tight tube 31. Here, the outlet of the polymerization reaction apparatus 100 means the leading end of the tube 30 or cylinder in the reacting region 13, or the outlet of the gauge pump 14 (FIG. 3) or of the pressure adjusting valve 16 (FIG. 4). In any case, the resin produced by each polymerization reaction apparatus 100 can be supplied into the reacting region 33 without being returned to normal pressures. As a result, the viscosity of each resin will lower in the presence of the compressive fluid, which makes it possible for the resins to be mixed in the mixing apparatus 41 at a lower temperature. FIG. 6 shows an example in which there are provided two polymerization reaction apparatuses 100 in parallel with the tube 31 including one joint 31a. However, three or more polymerization reaction apparatuses 100 may be provided in parallel with a plurality of joints.

The mixing apparatus 41 is not particularly limited as long as it can mix the resins supplied from the respective polymerization reaction apparatuses 100. Examples thereof include a mixing apparatus including a stirrer. The stirrer is not particularly limited and may be appropriately selected according to the purpose. Preferable examples of the stirrer include a uniaxial screw, biaxial screws meshing with each other, a biaxial mixer including multiple stirring elements meshing or overlapping with each other, a kneader including helical stirring elements meshing with each other, and a static mixer. The temperature (mixing temperature) when the mixing apparatus 41 mixes the resins may be set the same as the polymerization reaction temperature in the reacting region 13 of each polymerization reaction apparatus 100. The mixing apparatus 41 may include a separate mechanism configured to supply a compressive fluid to the resins being mixed. The pressure adjusting valve 42, as an example of a complex body outlet, is a device configured to adjust the flow rate of a resin porous material PP obtained by making a resin that contains a complex body obtained by mixing the resins in the mixing apparatus 41 porous.

In the second method, an L-form monomer and a D-form monomer (e.g., lactides) are polymerized separately in the respective polymerization reaction apparatuses 100 in advance in the compressive fluid. Then, the polymers obtained by the polymerization are blended in a compressive fluid to thereby obtain a stereo block copolymer (mixing step). Normally, a polymer such as a polylactic acid may often decompose when heated again to equal to or higher than the melting point, even if it contains very scarce residual monomer. The second method is useful because it can suppress racemization and thermal degradation like the first method, by blending polylactic acids having a low viscosity and melted in the compressive fluid at equal to or lower than the melting point.

In the first method and the second method, a case has been explained in which a stereo complex is produced by separately polymerizing ring-opening-polymerizable monomers that are each other's enantiomers. However, the ring-opening-polymerizable monomers used in the present embodiment need not be each other's enantiomers. Further, it is also possible to mix block copolymers each forming a stereo complex, by combining the first method and the second method.

### Third Embodiment

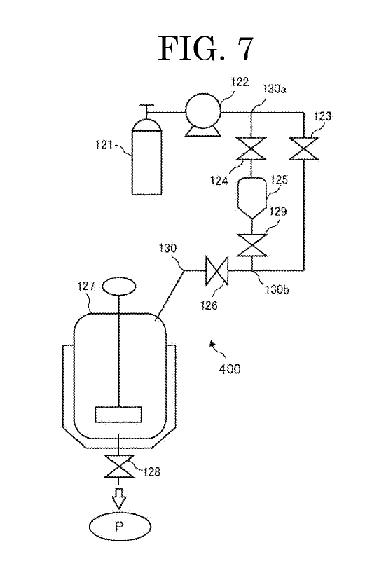

Next, a polymerization reaction apparatus 400 used in a batch-type process will be explained. In the system line diagram shown in FIG. 7, the polymerization reaction apparatus 400 includes a tank 121, a gauge pump 122, an adding pot 125, a reaction vessel 127, and valves (123, 124, 126, 128, 129). These devices are connected as shown in FIG. 7 through a pressure-tight tube 130. The tube 130 is provided with joints (130a, 130b).

The tank 121 stores a compressive fluid. The tank 121 may store a gaseous body (gas) or a solid that turns to a compressive fluid through the route through which it is supplied to the reaction vessel 127 or that turns to a compressive fluid by being heated or pressurized in the reaction vessel 127. In this case, the gaseous body or the solid stored in the tank 121 becomes the state of (1), (2), or (3) of the phase diagram of FIG. 2 in the reaction vessel 127 by being heated or pressurized.

The gauge pump 122 supplies the compressive fluid stored in the tank 121 to the reaction vessel 127 at a constant pressure at a constant flow rate. The adding pot 125 stores a catalyst to be added to the raw materials in the reaction vessel 127. The valves (123, 124, 126, 129) switch between a route of supplying the compressive fluid stored in the tank 121 to the reaction vessel 127 via the adding pot 125 and a route of supplying it to the reaction vessel 127 by bypassing the adding pot 125, by being opened or closed.

The reaction vessel 127 previously stores a ring-opening-polymerizable monomer, an initiator, and according to necessity, a filler material (e.g., an inorganic material) in advance of initiating polymerization. The reaction vessel 127 is a pressure-tight vessel in which to bring the ring-opening-polymerizable monomer, the initiator, etc. previously stored therein into contact with the compressive fluid supplied from the tank 121 and the catalyst supplied from the adding pot 125 to thereby ring-opening polymerize the ring-opening-polymerizable monomer. The reaction vessel 127 may be provided with a gas outlet through which an evaporant is removed. The reaction vessel 127 includes a heater configured to heat the raw materials and the compressive fluid. Further, the reaction vessel 127 includes a stirrer configured to stir the raw materials and the compressive fluid. When there occurs a density difference between the raw materials and the produced polymer, it is possible to suppress sedimentation of the produced polymer by applying stirring with the stirrer, which makes it possible to progress the polymerization reaction more uniformly and quantitatively. The valve 128 makes the resin in the reaction vessel 127 porous by being opened after the polymerization reaction is completed so as to rapidly expand the compressive fluid, and discharges the resin porous material P resulting from this porosity imparting.

When manufacturing the shaped product of the present invention, it is possible to perform porosity imparting and shaping simultaneously, by assembling any kind of shaping apparatus at the outlet of the producing apparatus (polymerization reaction apparatus) to allow the shaping to be performed while the compressive fluid contained in the resin is rapidly expanded.

### EXAMPLES

Examples of the present invention will be explained below. The present invention is not limited to these Examples by any means.

Physical properties of the resins obtained in Examples and Comparative Examples were obtained in the following manner. The physical properties include molecular weight, residual monomer content, strength, hydrolysis resistance, average pore diameter, and average pore wall thickness. The results of measurements and the results of evaluations are shown in Tables 1 to 9 below.

### <Molecular Weight>

The molecular weight was measured by GPC (Gel Permeation Chromatography) under the following conditions.
Instrument: GPC-8020 (manufactured by Tosoh Corporation)
Columns: TSK G2000HXL and G4000HXL (manufactured by Tosoh Corporation)
Temperature: 40° C.
Solvent: chloroform
Flow rate: 1.0 mL/minute

A sample having a concentration of 0.5% by mass (1 mL) was injected and measured under the above conditions to obtain a distribution of molecular weights of the polymer. Based on this, the number average molecular weight (Mn) and the weight average molecular weight (Mw) of the polymer were calculated, using a molecular weight calibration curve generated based on a monodisperse polystyrene standard sample. A molecular weight distribution was a value obtained by dividing Mw by Mn. The porous material was dissolved at a concentration of 0.2% by mass in chloroform, and then filtered through a 0.2 μm filter. The resulting filtrate was used as the sample.

### <Residual Monomer Content>

The residual monomer content was obtained according to the method of measuring a monomer content described in “Voluntary standards for container packaging of food with synthetic resins such as polyolefin, 3rd revision, supplemented in June, 2004, chapter 3, hygienic test methods, P13”. Specifically, a porous material of a polymer was uniformly dissolved in dichloromethane, and an acetone/cyclohexane mixture solution was added thereto to re-precipitate the polymer product. The resulting supernatant was subjected to a gas chromatograph (GC) with a hydrogen flame ionization detector (FID) to separate the residual monomer. The content of resulting monomer in the polymer product was measured by quantitation based on internal reference method. The GC measurement can be performed on the following conditions.

### (GC Measurement Conditions)

Column: a capillary column (manufactured by J&W Inc., DB-17MS, with a length of 30 m×inner diameter of 2.25 μm×a film thickness of 0.25 μm)
Internal reference: 2,6-dimethyl-γ-pyrone
Column flow rate: 1.8 mL/min
Column temperature: retained at 50° C. for 1 minute, warmed at a constant rate of 25° C./minute, and retained at 320° C. for 5 minutes.
Detector: a hydrogen flame ionization detection method (FID)

### <Strength>

Evaluation of strength was performed in the following manner.

A sheet having a thickness of 0.4 mm was manufactured. A 200 g weight was dropped down to the sheet to measure the maximum height from which the test piece would not be broken, and the strength was evaluated based on the following criteria.

### [Evaluation Criteria]

5: 400 mm or higher
4: 300 mm or higher but lower than 400 mm
3: 200 mm or higher but lower than 300 mm
2: 100 mm or higher but lower than 200 mm
1: lower than 100 mm

### <Hydrolysis Resistance>

Evaluation of hydrolysis resistance was performed in the following manner. The material was retained in warm water of 50° C. for 4 weeks. After this, the molecular weight of the material was measured to calculate the ratio of lowering of Mw. The hydrolysis resistance was evaluated based on the following criteria. A smaller ratio of lowering of Mw means a better hydrolysis resistance.

### [Evaluation Criteria]

5: lower than 10%
4: 10% or higher but lower than 20%
3: 20% or higher but lower than 30%
2: 30% or higher but lower than 40%
1: 40% or higher

### <Porosity, Average Pore Diameter, and Average Pore Wall Thickness>

A cross-section of the porous material was observed with a scanning electron microscope (FE-SEM) manufactured by JEOL Ltd. An image analyzing software program IMAGE-PRO PLUS was used for image analysis. A microtome was used for exposing a cross-section of the porous material. Microscopic observation of the average pore diameter was performed at the magnification shown in Table 1. Microscopic observation of the average pore wall thickness was performed at the magnification shown in Table 2.

The porosity was obtained in the following manner.

A cross-section of the porous material was expanded such that one side thereof may be observed in an image range of 500 μm, and a photograph of the expanded cross-section was captured.

A transparent sheet (such as an OHP sheet) was placed over the captured photograph, and portions corresponding to the pores were solidly blackened with a black ink.

The transparent sheet blackened with the black ink was imaged to recognize the portions blackened with the black ink with the image analyzing software, obtain the area of the portions blackened with the black ink, i.e., the area (Va) of the pores, and calculate the voidage (X) according to the following formula.

Porosity %=[area of the pores(Va)/area of the whole image]×100

The number of samples to be measured was 5 (n=5), and the average of the 5 samples was used as porosity (X).

The average pore diameter was obtained according to the following manner. At each microscope magnification shown in Table 1, 100 pores were randomly selected, and their circle equivalent diameter was obtained. A histogram at each magnification was generated. Note that any pore, of which pore diameter could not be wholly observed, such as one that was present at an edge of a SEM image, was not measured.

By setting a lower limit (or an upper limit) to the sampling of pores at each magnification, it was ensured that the same pore may not be measured twice.

The histograms at the respective magnifications thusly obtained were linked with each other as a pore diameter distribution of the porous material. A median diameter was used as the average pore diameter.

The average pore wall thickness was obtained according to the following manner. At each microscope magnification shown in Table 2, 100 pores were randomly selected, and their pore wall thickness was obtained. A histogram at each magnification was generated. By setting a lower limit (or an upper limit) to the sampling of pore wall thickness at each magnification, it was ensured that the same wall may not be measured twice.

The histograms at the respective magnifications thusly obtained were linked with each other as a pore wall thickness distribution of the porous material. A median thickness was used as the average pore wall thickness.

### <Mass Ratio of Compressive Fluid (% by Mass)>

The mass ratio of the compressive fluid (% by mass) was calculated according to the following formulae.

When the polymerization reaction apparatus 100 shown in FIG. 3 was used:

Mass ratio of compressive fluid(% by mass)=1−[raw materials (g)/[compressive fluid (g)+raw materials (g)]]

When the polymerization reaction apparatus 400 shown in FIG. 7 was used:

Spatial volume of supercritical carbon dioxide=100 mL−raw materials (g)/1.27(specific gravity of raw materials)

Mass of supercritical carbon dioxide=volume of raw materials (mL)×specific gravity of carbon dioxide

Mass ratio of compressive fluid(% by mass)=1−[raw materials (g)/[compressive fluid (g)+raw materials (g)]]

### <Specific Gravity of Carbon Dioxide>

Polymerization density (specific gravity of carbon dioxide) was obtained based on a reference 'R. Span and W. Wagner “A New Equation of State for Carbon Dioxide covering the Fluid Region from the Triple Point Temperature to 1100 K at Pressures up to 800 MPa” J. Phys. Chem. Ref. Data 25, pp. 1,509-1,596 (1996)’.

### Example 1

Ring-opening polymerization of L-lactide (manufactured by Pulac Inc.) was performed with the polymerization reaction apparatus 100 shown in FIG. 3. The configuration of the polymerization reaction apparatus 100 is described below.

Tank 1, Gauge Feeder 2:

Plunger pump NP-S462 manufactured by Nihon Seimitsu Co., Ltd. The tank 1 was filled with molten lactide as the ring-opening-polymerizable monomer.

Tank 3, Gauge Feeder 4:

Intelligent HPLC pump (PU-2080) manufactured by Jasco Corporation. The tank 3 was filled with lauryl alcohol as the initiator.

Tank 5, Gauge Pump 6:

Not used in the present Example.

Tank 7:

Carbonic acid gas cylinder

Tank 11, Gauge Pump 12:

Intelligent HPLC pump (PU-2080) manufactured by Jasco Corporation. The tank 11 was filled with DBU (diazabicycloundecen; organic catalyst).

Melt Mixing Apparatus (Contact Region 9):

Biaxial stirrer equipped with screws meshing with each other
Cylinder inner diameter of 30 mm
Cylinder set temperature of 100° C.
The same direction of rotation for both of the two axes
Rotation speed of 30 rpm

Reaction Vessel (Reacting Region 13):

Biaxial kneader
Cylinder inner diameter of 40 mm
Cylinder set temperature of 100° C. at the raw materials supply portion
The same direction of rotation for both of the two axes
Rotation speed of 60 rpm

The contact region 9 and the reacting region 13 were actuated at the setting conditions described above. The gauge feeder 2 volumetrically fed the molten lactide in the tank 1 into the container of the contact region 9. The gauge feeder 4 volumetrically fed the lauryl alcohol in the tank 3 into the container of the contact region 9 in an amount of 0.1 mol relative to the feeding amount of the lactide of 99.9 mol. The gauge pump 8 fed the carbonic acid gas (carbon dioxide) as the compressive fluid in the tank 7 such that the pressure inside the container of the contact region 9 would be 15 MPa. As a result, the contact region 9 brought the raw materials, namely lactide and lauryl alcohol and the compressive fluid supplied from the tanks (1, 3, 7) into contact with one another serially and mixed them with the screws to thereby melt the raw materials.

The raw materials melted in the contact region 9 were conveyed by the liquid conveying pump 10 to the reacting region 13. The gauge pump 12 fed the organic catalyst (DBU) in the tank 11 to the raw material feeding port of the biaxial kneader as the reacting region 13 in an amount of 0.05 mol relative to 99.95 mol of lactide. In the reacting region 13, the raw materials conveyed by the liquid conveying pump 10 were with the DBU fed by the gauge pump 12 to thereby ring-opening polymerize the lactide. In this case, the average retention time of the raw materials in the reacting region 13 was about 1,200 seconds. The temperature of the reacting region 13 was set to 60° C. the mass ratio of the compressive fluid (% by mass) during polymerization was set to 10% by mass. The leading end of the reacting region 13 was fitted with the gauge pump 14 and the porosity imparting unit 15. The pressure and temperature of the porosity imparting unit 15 were set the same as those during polymerization. The compressive fluid was added to set the mass ratio of the compressive fluid to 50% by mass. The resulting polymerization product was extruded from a slit-shaped die while the compressive fluid was rapidly expanded so as to reach normal pressures in 1 second, to thereby obtain a porous material sheet of 0.4 mm. The physical properties (Mw, Mw/Mn, residual monomer content, porosity, average pore diameter, average pore wall thickness, strength, and hydrolysis resistance) of the obtained porous material were obtained according to the manners described above. The results are shown in Table 3-1.

### Examples 2 to 20

Porous materials were produced in the same manner as Example 1, except that catalyst, amount of initiator, polymerization pressure, polymerization temperature, mass ratio of compressive fluid during polymerization, and mass ratio of compressive fluid during porosity imparting were changed to the conditions shown in Tables 3-1 and 3-2.

### Examples 21 to 30

The tank 5 was charged with hydroxy apatite (SHAp, manufactured by SofSera Corporation), and the pump 6 was used. Porous materials were produced in the same manner as Example 1, except that catalyst, amount of initiator, polymerization pressure, polymerization temperature, mass ratio of compressive fluid during polymerization, and mass ratio of compressive fluid during porosity imparting were changed to the conditions shown in Tables 3-3-1 and 3-3-2. β-TCP of Example 24 was 13-TCP-100 manufactured by Taihei Chemical Industrial Co., Ltd.

### Examples 31 to 33

Porous materials were produced in the same manner as Example 21, except that the apparatus shown in FIG. 5 was used, and catalyst, amount of initiator, polymerization pressure, polymerization temperature, mass ratio of compressive fluid during polymerization, and mass ratio of compressive fluid during porosity imparting were changed to the conditions shown in Table 4. A monomer 1 was polymerized with a first polymerization reaction apparatus 201, and a monomer 2 was polymerized with a second polymerization reaction apparatus 202. Polymerization pressure, polymerization temperature, and mass ratio of compressive fluid during polymerization in the polymerization with the first polymerization reaction apparatus 201 were the same as those in the polymerization with the second polymerization reaction apparatus 202.

### Examples 34 and 35

Porous materials were produced with the apparatus shown in FIG. 5 in the same manner as Example 31, except that catalyst, amount of initiator, polymerization pressure, polymerization temperature, mass ratio of compressive fluid during polymerization, and mass ratio of compressive fluid during porosity imparting were changed to the conditions shown in Table 5-1. The tank and pump used in Example 31 for feeding the inorganic material were not used.

### Example 36

A porous material was produced in the same manner as Example 1, except that the apparatus shown in FIG. 6 was used, and catalyst, amount of initiator, polymerization pressure, polymerization temperature, mass ratio of compressive fluid during polymerization, and mass ratio of compressive fluid during porosity imparting were changed to the conditions shown in Table 5-1. A monomer 1 and a monomer 2 were polymerized with the respective polymerization reaction apparatuses 100. The resulting polymerization products were mixed in the mixing apparatus 41, and with the compressive fluid added, the resulting product was extruded from a slit-shaped die while it was rapidly expanded to normal pressures in 1 second, to thereby obtain a porous material sheet of 0.4 mm.

Mixing Apparatus 41:

Biaxial stirrer equipped with screws meshing with each other
Cylinder inner diameter of 40 mm
The same direction of rotation for both of the two axes
Rotation speed of 30 rpm

### Examples 37 to 40

Porous materials were produced with the apparatus of FIG. 5 in the same manner as Example 34, except that catalyst, amount of initiator, polymerization pressure, polymerization temperature, mass ratio of compressive fluid during polymerization, and mass ratio of compressive fluid during porosity imparting were changed to the conditions shown in Tables 5-1 and 5-2.

### Examples 41 to 43

Porous materials were produced in the same manner as Example 1, except that hexandiol was used as initiator (in Example 41), DURANOL T5652 manufactured by Asahi Kasei Corporation was used as aliphatic polycarbonate diol (in Example 42), OD-X-668 manufactured by DIC Corporation was used as polyester diol (in Example 43), and catalyst, amount of initiator, polymerization pressure, polymerization temperature, mass ratio of compressive fluid during polymerization, and mass ratio of compressive fluid during porosity imparting were changed to the conditions shown in Table 5-2.

### Examples 44 and 47

Porous materials were produced in the same manner as Example 1, except that apparatus shown in FIG. 7 was used, and catalyst, amount of initiator, polymerization pressure, polymerization temperature, mass ratio of compressive fluid during polymerization, and mass ratio of compressive fluid during porosity imparting were changed to the conditions shown in Tables 6-1 and 6-2. The obtained porous material was pulverized with a counter jet mill (manufactured by Hosokawa Micron Corporation) to obtain particles having a volume average particle diameter of 6 μm.

### Examples 45 and 48

Porous materials were produced in the same manner as Example 1, except that the apparatus shown in FIG. 7 was used, and catalyst, amount of initiator, polymerization pressure, polymerization temperature, mass ratio of compressive fluid during polymerization, and mass ratio of compressive fluid during porosity imparting were changed to the conditions shown in Tables 6-1 and 6-2. The obtained porous material was molded into a film with a thickness of 100 μm with a general inflation molding apparatus.

### Examples 46 and 49

Porous materials were produced in the same manner as Example 1, except that the apparatus shown in FIG. 7 was used, and catalyst, amount of initiator, polymerization pressure, polymerization temperature, mass ratio of compressive fluid during polymerization, and mass ratio of compressive fluid during porosity imparting were changed to the conditions shown in Tables 6-1 and 6-2. The obtained porous material was spun with a publicly-known simplified melt spinning machine (CAPIROGRAPH 1D PMD-C manufactured by Toyo Seiki Co., Ltd.) and stretched with a hot-air stretching machine to thereby obtain a monofilament.

### Examples 50 to 59

The polymerization reaction apparatus 400 shown in FIG. 7 was used. A CO₂ cylinder was used as the tank 121 of the polymerization reaction apparatus 400. A 100 mL batch-type pressure vessel was used as the reaction vessel 127 of the polymerization reaction apparatus 400. The mass ratio of compressive fluid during porosity imparting and the mass ratio of compressive fluid during polymerization were the same. Porous materials were produced under the conditions shown in Tables 7-1 and 7-2.

### Examples 60 to 64

Porous materials were produced with the polymerization reaction apparatus 400 shown in FIG. 7 and the system shown in FIG. 5A under the conditions shown in Tables 8-1 and 8-2. The mass ratio of compressive fluid during porosity imparting and the mass ratio of compressive fluid during polymerization were the same.

### Comparative Example 1

Polymerization was performed under the conditions of Example 1, and the polymerization product was taken out from the compressive fluid. The taken-out polymerization product was put in a pressure vessel, which was then heated to 200° C. while being supplied with CO₂ to be 20 MPa. The mass ratio of compressive fluid during porosity imparting was 50% by mass. After stirred for 2 hours, the polymerization product was extruded from a slit-shaped die while being rapidly expanded to normal pressures in 1 second, to thereby obtain a porous material sheet of 0.4 mm. The results are shown in Table 9.

### Comparative Example 2

Polymerization was performed under the conditions of Example 3, and the polymerization product was taken out from the compressive fluid. The taken-out polymerization product was put in a pressure vessel, which was then heated to 200° C. while being supplied with CO₂ to be 20 MPa. The mass ratio of compressive fluid during porosity imparting was 70% by mass. After stirred for 2 hours, the polymerization product was extruded from a slit-shaped die while being rapidly expanded to normal pressures in 1 second, to thereby obtain a porous material sheet of 0.4 mm. The results are shown in Table 9.

### Comparative Example 3

Polymerization was performed with the polymerization reaction apparatus 400 of FIG. 7 under the conditions shown in Table 9, and the obtained polymerization product was taken out from the compressive fluid. The taken-out polymerization product was put in a pressure vessel, which was then heated to 200° C. while being supplied with CO₂ to be 20 MPa. The mass ratio of compressive fluid during porosity imparting was 10% by mass. After stirred for 2 hours, the polymerization product was extruded from a slit-shaped die while being rapidly expanded to normal pressures in 1 second, to thereby obtain a porous material sheet of 0.4 mm. The results are shown in Table 9.

### Comparative Example 4

L-lactide (170 g), D-lactide (30 g), and hydroxy apatite (SHAp manufactured by SofSera Corporation) were put into a 300 mL four-necked separable flask, the internal temperature was gradually raised up to 150° C., and then, the materials were dehydrated for 30 minutes at 10 mmHg. Then, while being purged with N₂, the flask was warmed up to 170° C. After it was confirmed by visual observation that the system was homogenized, tin 2-ethylhexanoate (50 mg) was added to the system to progress polymerization reaction. At this time, the internal temperature of the system was controlled so as not to exceed 190° C. After the reaction time of 2 hours passed, the system was switched again to a drain line to remove lactide under the conditions of 190° C. and 10 mmHg and terminate the polymerization reaction to thereby obtain a resin.

Then, the resin was made porous according to a freezing drying method.

The inorganic material was not in a favorable dispersed state, and was present in the form of agglutinates. The polymerization time took 4 times longer than in Examples of the present invention, and the porosity imparting step also took 10 times or more longer than in Examples of the present invention.

TABLE 3-1

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Monomer kind | L-lactide | L-lactide | L-lactide | L-lactide | L-lactide | L-lactide | L-lactide | L-lactide | L-lactide | L-lactide |
| Catalyst | DBU | DBU | Tin | Tin | Tin | Tin | Tin | Tin | Tin | Tin |
| | | | octylate | octylate | octylate | octylate | octylate | octylate | octylate | octylate |
| Initiator octylatekind | Lauryl | Lauryl | Lauryl | Lauryl | Lauryl | Lauryl | Lauryl | Lauryl | Lauryl | Lauryl |
| | alcohol | alcohol | alcohol | alcohol | alcohol | alcohol | alcohol | alcohol | alcohol | alcohol |
| Initiator amount (mol %) | 0.1 | 0.05 | 0.05 | 0.1 | 0.1 | 0.05 | 0.02 | 0.02 | 0.5 | 0.5 |
| Polymerization pressure | 20 | 15 | 20 | 20 | 15 | 17 | 40 | 40 | 15 | 15 |
| (MPa) | | | | | | | | | | |
| Polymerization | 60 | 60 | 150 | 150 | 150 | 150 | 150 | 150 | 150 | 150 |
| temperature (° C.) | | | | | | | | | | |
| Compressive fluid mass | 10 | 5 | 10 | 10 | 5 | 10 | 10 | 5 | 10 | 10 |
| ratio during polymerization | | | | | | | | | | |
| (% by mass) | | | | | | | | | | |
| Compressive fluid mass | 50 | 20 | 70 | 30 | 50 | 50 | 30 | 50 | 70 | 70 |
| ratio during porosity | | | | | | | | | | |
| imparting (% by mass) | | | | | | | | | | |
| Mw | 310000 | 350000 | 370000 | 300000 | 320000 | 410000 | 530000 | 510000 | 360000 | 520000 |
| Mw/Mn | 1.2 | 1.4 | 1.9 | 1.8 | 1.9 | 1.9 | 1.9 | 1.8 | 1.3 | 1.4 |
| Residual monomer | 300 | 3000 | 20000 | 4000 | 11000 | 13000 | 9000 | 800 | 1100 | 700 |
| (ppm) | | | | | | | | | | |
| Porosity (%) | 70 | 95 | 78 | 81 | 97 | 98 | 82 | 95 | 97 | 94 |
| Ave. pore diameter (μm) | 17 | 167 | 34 | 28 | 104 | 53 | 47 | 218 | 87 | 73 |
| Ave. pore wall thickness | 0.3 | 0.8 | 0.9 | 1 | 0.4 | 0.5 | 0.7 | 0.4 | 0.3 | 0.2 |
| (μm) | | | | | | | | | | |
| Strength | 3 | 3 | 4 | 3 | 3 | 4 | 5 | 5 | 3 | 5 |
| Hydrolysis resistance | 4 | 3 | 3 | 3 | 5 | 4 | 4 | 5 | 5 | 5 |

TABLE 3-2

| | Ex. 11 | Ex. 12 | Ex. 13 | Ex. 14 | Ex. 15 | Ex. 16 | Ex. 17 | Ex. 18 | Ex. 19 | Ex. 20 |
|---|---|---|---|---|---|---|---|---|---|---|
| Monomer kind | ε- | ε- | ε- | Ethylene | Ethylene | Propylene | Dioxanone | Glycolide | Glycolide | Glycolide |
| | caprolactone | caprolactone | caprolactone | carbonate | carbonate | carbonate | | | | |
| Catalyst | DBU | Tin | Tin | DMAP | Tin | DMAP | DMAP | DMAP | DMAP | Tin |
| | | octylate | octylate | | octylate | | | | | octylate |
| Initiator kind | Lauryl | Lauryl | Lauryl | Lauryl | Lauryl | Lauryl | Lauryl | Lauryl | Lauryl | Lauryl |
| | alcohol | alcohol | alcohol | alcohol | alcohol | alcohol | alcohol | alcohol | alcohol | alcohol |
| Initiator amount | 0.1 | 0.05 | 0.02 | 0.1 | 0.05 | 0.05 | 0.05 | 0.1 | 0.05 | 0.05 |
| (mol %) | | | | | | | | | | |
| Polymerization | 20 | 15 | 20 | 20 | 15 | 17 | 17 | 12 | 15 | 15 |
| pressure (MPa) | | | | | | | | | | |
| Polymerization | 60 | 150 | 150 | 120 | 120 | 120 | 120 | 120 | 120 | 150 |
| temperature (° C.) | | | | | | | | | | |
| Compressive fluid | 10 | 5 | 10 | 5 | 5 | 5 | 10 | 10 | 10 | 10 |
| mass ratio during | | | | | | | | | | |
| polymerization | | | | | | | | | | |
| (% by mass) | | | | | | | | | | |
| Compressive fluid | 30 | 10 | 50 | 50 | 50 | 50 | 70 | 50 | 50 | 70 |
| mass ratio during | | | | | | | | | | |
| porosity imparting | | | | | | | | | | |
| (% by mass) | | | | | | | | | | |
| Mw | 320000 | 410000 | 490000 | 330000 | 370000 | 330000 | 320000 | 320000 | 330000 | 510000 |
| Mw/Mn | 1.6 | 1.5 | 1.7 | 1.3 | 1.6 | 2.1 | 1.9 | 1.6 | 1.3 | 1.8 |
| Residual monomer | 300 | 3000 | 400 | 700 | 1300 | 21000 | 9000 | 17000 | 1700 | 600 |
| (ppm) | | | | | | | | | | |
| Porosity (%) | 92 | 83 | 96 | 93 | 94 | 78 | 79 | 84 | 89 | 97 |
| Ave. pore diameter | 96 | 29 | 197 | 83 | 41 | 27 | 12 | 33 | 49 | 78 |
| (μm) | | | | | | | | | | |
| Ave. pore wall | 0.8 | 1 | 0.2 | 0.3 | 0.3 | 0.3 | 0.2 | 0.7 | 0.6 | 0.2 |
| thickness (μm) | | | | | | | | | | |
| Strength | 3 | 4 | 4 | 3 | 4 | 3 | 3 | 3 | 3 | 5 |
| Hydrolysis resistance | 4 | 3 | 5 | 5 | 4 | 4 | 5 | 3 | 3 | 5 |

TABLE 3-3-1

| | Ex. 21 | Ex. 22 | Ex. 23 | Ex. 24 | Ex. 25 |
|---|---|---|---|---|---|
| Monomer kind | L-lactide | L-lactide | L-lactide | L-lactide | L-lactide |
| Catalyst | DBU | DBU | DBU | DBU | Tin |
| | | | | | octylate |
| Initiator kind | Lauryl | Lauryl | Lauryl | Lauryl | Lauryl |
| | alcohol | alcohol | alcohol | alcohol | alcohol |
| Initiator amount | 0.05 | 0.05 | 0.05 | 0.05 | 0.05 |
| (mol %) | | | | | |
| Filler material | Hydroxy | Hydroxy | Hydroxy | β-TCP | Hydroxy |
| | apatite | apatite | apatite | | apatite |
| Compounding | 5 | 15 | 25 | 10 | 10 |
| amount of filler | | | | | |
| material (part | | | | | |
| by mass) | | | | | |
| Polymerization | 20 | 20 | 20 | 15 | 40 |
| pressure (MPa) | | | | | |
| Polymerization | 60 | 60 | 60 | 60 | 150 |
| temperature | | | | | |
| (° C.) | | | | | |
| Compressive | 10 | 10 | 10 | 10 | 5 |
| fluid mass ratio | | | | | |
| during | | | | | |
| polymerization | | | | | |
| (% by mass) | | | | | |
| Compressive | 30 | 30 | 30 | 50 | 50 |
| fluid mass ratio | | | | | |
| during porosity | | | | | |
| imparting | | | | | |
| (% by mass) | | | | | |
| Mw | 470000 | 430000 | 330000 | 430000 | 520000 |
| Mw/Mn | 1.4 | 1.7 | 1.6 | 1.8 | 1.6 |
| Filler material | 5 | 13 | 21 | 9 | 9 |
| content in porous | | | | | |
| material | | | | | |
| (% by mass) | | | | | |
| Residual monomer | 600 | 2300 | 1200 | 2300 | 4300 |
| (ppm) | | | | | |
| Porosity (%) | 89 | 92 | 96 | 81 | 98 |
| Ave. pore | 77 | 56 | 17 | 29 | 71 |
| diameter (μm) | | | | | |
| Ave. pore wall | 0.9 | 0.7 | 0.4 | 0.3 | 0.3 |
| thickness (μm) | | | | | |
| Strength | 5 | 5 | 4 | 5 | 5 |
| Hydrolysis | 3 | 4 | 5 | 4 | 5 |
| resistance | | | | | |

TABLE 3-3-2

| | Ex. 26 | Ex. 27 | Ex. 28 | Ex. 29 | Ex. 30 |
|---|---|---|---|---|---|
| Monomer kind | ε- | Ethylene | L-lactide | L-lactide | L-lactide |
| | caprolactone | carbonate | | | |
| Catalyst | DBU | DBU | Tin | Tin | Tin |
| | | | octylate | octylate | octylate |
| Initiator kind | Lauryl | Lauryl | Lauryl | Lauryl | Lauryl |
| | alcohol | alcohol | alcohol | alcohol | alcohol |
| Initiator amount | 0.05 | 0.05 | 0.05 | 0.05 | 0.05 |
| (mol %) | | | | | |
| Filler material | Hydroxy | Hydroxy | Carbon | Gibbsite | Diaspore |
| | apatite | apatite | nanotube | | |
| Compounding | 10 | 10 | 10 | 10 | 10 |
| amount of filler | | | | | |
| material (part | | | | | |
| by mass) | | | | | |
| Polymerization | 30 | 30 | 40 | 40 | 40 |
| pressure (MPa) | | | | | |
| Polymerization | 60 | 80 | 150 | 150 | 150 |
| temperature | | | | | |
| (° C.) | | | | | |
| Compressive | 10 | 10 | 5 | 5 | 5 |
| fluid mass ratio | | | | | |
| during | | | | | |
| polymerization | | | | | |
| (% by mass) | | | | | |
| Compressive | 30 | 30 | 50 | 50 | 50 |
| fluid mass ratio | | | | | |
| during porosity | | | | | |
| imparting | | | | | |
| (% by mass) | | | | | |
| Mw | 390000 | 380000 | 540000 | 560000 | 580000 |
| Mw/Mn | 1.5 | 1.7 | 1.7 | 1.8 | 1.6 |
| Filler material | 9 | 8 | 9 | 8 | 9 |
| content in porous | | | | | |
| material | | | | | |
| (% by mass) | | | | | |
| Residual monomer | 900 | 5200 | 3800 | 4200 | 1600 |
| (ppm) | | | | | |
| Porosity (%) | 87 | 76 | 91 | 89 | 94 |
| Ave. pore | 63 | 43 | 77 | 59 | 63 |
| diameter (μm) | | | | | |
| Ave. pore wall | 0.2 | 0.6 | 0.2 | 0.4 | 0.3 |
| thickness (μm) | | | | | |
| Strength | 5 | 5 | 5 | 5 | 5 |
| Hydrolysis | 5 | 4 | 5 | 4 | 5 |
| resistance | | | | | |

TABLE 4

| | Ex. 31 | Ex. 32 | Ex. 33 |
|---|---|---|---|
| Monomer 1 | L-lactide | L-lactide | L-lactide |
| Monomer 2 | D-lactide | D-lactide | ε- |
| | | | caprolactone |
| Catalyst | DBU | Tin | Tin |
| | | octylate | octylate |
| Initiator kind | Lauryl | Lauryl | Lauryl |
| | alcohol | alcohol | alcohol |
| Initiator amount | 0.1 | 0.05 | 0.05 |
| (mol %) | | | |
| Inorganic | Hydroxy | Hydroxy | Hydroxy |
| material | apatite | apatite | apatite |
| Compounding | 15 | 15 | 15 |
| amount of | | | |
| inorganic | | | |
| material | | | |
| (part by mass) | | | |
| Polymerization | 20 | 25 | 25 |
| pressure (MPa) | | | |
| Polymerization | 60 | 150 | 150 |
| temperature | | | |
| (° C.) | | | |
| Compressive | 10 | 10 | 10 |
| fluid mass ratio | | | |
| during | | | |
| polymerization | | | |
| (% by mass) | | | |
| Compressive | 30 | 50 | 50 |
| fluid mass ratio | | | |
| during porosity | | | |
| imparting | | | |
| (% by mass) | | | |
| Mw | 330000 | 430000 | 490000 |
| Mw/Mn | 1.3 | 1.5 | 1.6 |
| Inorganic | 14 | 13 | 14 |
| material content | | | |
| in porous | | | |
| material | | | |
| (% by mass) | | | |
| Residual monomer | 800 | 1900 | 2100 |
| (ppm) | | | |
| Porosity (%) | 92 | 98 | 97 |
| Ave. pore | 96 | 72 | 66 |
| diameter (μm) | | | |
| Ave. pore wall | 0.9 | 0.3 | 0.2 |
| thickness (μm) | | | |
| Strength | 3 | 5 | 5 |
| Hydrolysis | 3 | 5 | 5 |
| resistance | | | |

TABLE 5-1

| | Ex. 34 | Ex. 35 | Ex. 36 | Ex. 37 | Ex. 38 |
|---|---|---|---|---|---|
| Monomer 1 | L-lactide | L-lactide | L-lactide | L-lactide | L-lactide |
| Monomer 2 | D-lactide | D-lactide | D-lactide | ε- | ε- |
| | | | | caprolactone | caprolactone |
| Catalyst | DBU | Tin | Tin | DBU | Tin |
| | | octylate | octylate | | octylate |
| Initiator kind | Lauryl | Lauryl | Lauryl | Lauryl | Lauryl |
| | alcohol | alcohol | alcohol | alcohol | alcohol |
| Initiator amount | 0.1 | 0.05 | 0.05 | 0.1 | 0.02 |
| (mol %) | | | | | |
| Polymerization | 15 | 15 | 20 | 20 | 15 |
| pressure (MPa) | | | | | |
| Polymerization | 60 | 120 | 150 | 150 | 150 |
| temperature | | | | | |
| (° C.) | | | | | |
| Compressive | 10 | 5 | 10 | 10 | 5 |
| fluid mass ratio | | | | | |
| during | | | | | |
| polymerization | | | | | |
| (% by mass) | | | | | |
| Compressive | 70 | 10 | 70 | 30 | 50 |
| fluid mass ratio | | | | | |
| during porosity | | | | | |
| imparting | | | | | |
| (% by mass) | | | | | |
| Mw | 320000 | 470000 | 560000 | 300000 | 510000 |
| Mw/Mn | 1.1 | 1.4 | 2.2 | 1.7 | 1.3 |
| Residual monomer | 500 | 3000 | 2000 | 2100 | 900 |
| (ppm) | | | | | |
| Porosity (%) | 75 | 96 | 82 | 78 | 97 |
| Ave. pore | 186 | 34 | 167 | 31 | 258 |
| diameter (μm) | | | | | |
| Ave. pore wall | 0.2 | 0.9 | 0.8 | 0.9 | 0.3 |
| thickness (μm) | | | | | |
| Strength | 3 | 4 | 5 | 3 | 5 |
| Hydrolysis | 5 | 4 | 4 | 4 | 5 |
| resistance | | | | | |

TABLE 5-2

| | Ex. 39 | Ex. 40 | Ex. 41 | Ex. 42 | Ex. 43 |
|---|---|---|---|---|---|
| Monomer 1 | L-lactide | L-lactide | L-lactide | L-lactide | L-lactide |
| Monomer 2 | glycolide | Ethylene | D-lactide | D-lactide | D-lactide |
| | | carbonate | | | |
| Catalyst | DMAP | DMAP | Tin | Tin | Tin |
| | | | octylate | octylate | octylate |
| Initiator kind | Lauryl | Lauryl | Hexanediol | Polycarbonate | Polyester |
| | alcohol | alcohol | | diol | diol |
| Initiator amount | 0.05 | 0.1 | 0.02 | 0.5 | 0.5 |
| (mol %) | | | | | |
| Polymerization | 17 | 17 | 12 | 15 | 15 |
| pressure (MPa) | | | | | |
| Polymerization | 150 | 150 | 150 | 150 | 150 |
| temperature | | | | | |
| (° C.) | | | | | |
| Compressive | 10 | 10 | 5 | 10 | 10 |
| fluid mass ratio | | | | | |
| during | | | | | |
| polymerization | | | | | |
| (% by mass) | | | | | |
| Compressive | 30 | 30 | 50 | 70 | 70 |
| fluid mass ratio | | | | | |
| during porosity | | | | | |
| imparting | | | | | |
| (% by mass) | | | | | |
| Mw | 310000 | 330000 | 550000 | 360000 | 530000 |
| Mw/Mn | 1.6 | 1.7 | 1.6 | 1.2 | 1.5 |
| Residual monomer | 7300 | 5300 | 600 | 1700 | 300 |
| (ppm) | | | | | |
| Porosity (%) | 84 | 91 | 98 | 97 | 96 |
| Ave. pore | 68 | 153 | 406 | 96 | 213 |
| diameter (μm) | | | | | |
| Ave. pore wall | 0.7 | 0.4 | 0.2 | 0.3 | 0.2 |
| thickness (μm) | | | | | |
| Strength | 3 | 3 | 5 | 4 | 5 |
| Hydrolysis | 4 | 5 | 5 | 5 | 5 |
| resistance | | | | | |

TABLE 6-1

| | Ex. 44 | Ex. 45 | Ex. 46 |
|---|---|---|---|
| Monomer kind | Lactide | Lactide | Lactide |
| Catalyst | DBU | Tin | Tin |
| | | octylate | octylate |
| Initiator kind | Lauryl | Lauryl | Lauryl |
| | alcohol | alcohol | alcohol |
| Initiator amount | 0.05 | 0.05 | 0.05 |
| (mol %) | | | |
| Polymerization | 20 | 15 | 20 |
| pressure (MPa) | | | |
| Polymerization | 60 | 60 | 150 |
| temperature | | | |
| (° C.) | | | |
| Compressive | 10 | 5 | 10 |
| fluid mass ratio | | | |
| during | | | |
| polymerization | | | |
| (% by mass) | | | |
| Compressive | 50 | 70 | 70 |
| fluid mass ratio | | | |
| during porosity | | | |
| imparting | | | |
| (% by mass) | | | |
| Mw | 340000 | 430000 | 480000 |
| Mw/Mn | 1.3 | 1.2 | 1.7 |
| Residual monomer | 4200 | 400 | 3200 |
| (ppm) | | | |
| Porosity (%) | 89 | 91 | 93 |
| Ave. pore | 37 | 18 | 78 |
| diameter (μm) | | | |
| Ave. pore wall | 0.3 | 0.2 | 0.2 |
| thickness (μm) | | | |

TABLE 6-2

| | Ex. 47 | Ex. 48 | Ex. 49 |
|---|---|---|---|
| Monomer kind | Lactide | Lactide | Lactide |
| Catalyst | DBU | Tin | Tin |
| | | octylate | octylate |
| Initiator kind | Lauryl | Lauryl | Lauryl |
| | alcohol | alcohol | alcohol |
| Initiator amount | 0.05 | 0.05 | 0.05 |
| (mol %) | | | |
| Inorganic | Hydroxy | Hydroxy | Hydroxy |
| material | apatite | apatite | apatite |
| Compounding | 10 | 10 | 10 |
| amount of | | | |
| inorganic | | | |
| material (part | | | |
| by mass) | | | |
| Polymerization | 20 | 15 | 20 |
| pressure (MPa) | | | |
| Polymerization | 60 | 60 | 150 |
| temperature | | | |
| (° C.) | | | |
| Compressive | 10 | 5 | 10 |
| fluid mass ratio | | | |
| during | | | |
| polymerization | | | |
| (% by mass) | | | |
| Compressive | 50 | 70 | 70 |
| fluid mass ratio | | | |
| during porosity | | | |
| imparting | | | |
| (% by mass) | | | |
| Mw | 340000 | 430000 | 480000 |
| Mw/Mn | 1.2 | 1.4 | 1.6 |
| Inorganic | 10 | 9 | 8 |
| material | | | |
| content in resin | | | |
| porous material | | | |
| (% by mass) | | | |
| Residual monomer | 2600 | 800 | 4300 |
| (ppm) | | | |
| Porosity (%) | 88 | 96 | 97 |
| Ave. pore | 48 | 24 | 74 |
| diameter (μm) | | | |
| Ave. pore wall | 0.4 | 0.3 | 0.2 |
| thickness (μm) | | | |

TABLE 7-1

| | Ex. 50 | Ex. 51 | Ex. 52 | Ex. 53 |
|---|---|---|---|---|
| Monomer kind | L-lactide | L-lactide | ε- | Ethylene |
| | | | caprolactone | carbonate |
| Catalyst | DBU | Tin | Tin | DMAP |
| | | octylate | octylate | |
| Initiator kind | Lauryl | Lauryl | Lauryl | Lauryl |
| | alcohol | alcohol | alcohol | alcohol |
| Initiator amount | 0.05 | 0.02 | 0.02 | 0.02 |
| (mol %) | | | | |
| Polymerization | 20 | 15 | 20 | 20 |
| pressure (MPa) | | | | |
| Polymerization | 60 | 150 | 150 | 170 |
| temperature | | | | |
| (° C.) | | | | |
| Compressive | 20 | 10 | 20 | 20 |
| fluid mass ratio | | | | |
| during | | | | |
| polymerization | | | | |
| (% by mass) | | | | |
| Mw | 330000 | 550000 | 560000 | 490000 |
| Mw/Mn | 1.2 | 1.4 | 1.3 | 1.4 |
| Residual monomer | 900 | 1100 | 700 | 2900 |
| (ppm) | | | | |
| Porosity (%) | 70 | 78 | 85 | 81 |
| Ave. pore | 59 | 117 | 185 | 37 |
| diameter (μm) | | | | |
| Ave. pore wall | 0.8 | 0.7 | 0.4 | 0.9 |
| thickness (μm) | | | | |
| Strength | 3 | 5 | 5 | 5 |
| Hydrolysis | 3 | 3 | 4 | 3 |
| resistance | | | | |

TABLE 7-2

| | Ex. 54 | Ex. 55 | Ex. 56 | Ex. 57 | Ex. 58 | Ex. 59 |
|---|---|---|---|---|---|---|
| Monomer kind | L-lactide | L-lactide | L-lactide | L-lactide | ε- | Ethylene |
| | | | | | caprolactone | carbonate |
| Catalyst | DBU | DBU | DBU | Tin | DBU | DBU |
| | | | | octylate | | |
| Initiator kind | Lauryl | Lauryl | Lauryl | Lauryl | Lauryl | Lauryl |
| | alcohol | alcohol | alcohol | alcohol | alcohol | alcohol |
| Initiator amount | 0.02 | 0.02 | 0.02 | 0.02 | 0.02 | 0.02 |
| (mol %) | | | | | | |
| Inorganic | Hydroxy | Hydroxy | β-TCP | Hydroxy | Hydroxy | Hydroxy |
| material | apatite | apatite | | apatite | apatite | apatite |
| Compounding | 5 | 25 | 10 | 10 | 10 | 10 |
| amount of | | | | | | |
| inorganic | | | | | | |
| material (part | | | | | | |
| by mass) | | | | | | |
| Polymerization | 30 | 30 | 30 | 40 | 30 | 30 |
| pressure (MPa) | | | | | | |
| Polymerization | 60 | 60 | 60 | 150 | 60 | 80 |
| temperature | | | | | | |
| (° C.) | | | | | | |
| Compressive | 20 | 20 | 20 | 20 | 20 | 20 |
| fluid mass ratio | | | | | | |
| during | | | | | | |
| polymerization | | | | | | |
| (% by mass) | | | | | | |
| Mw | 430000 | 310000 | 410000 | 500000 | 410000 | 360000 |
| Mw/Mn | 1.4 | 1.5 | 1.6 | 1.4 | 1.5 | 1.3 |
| Inorganic | 5 | 22 | 9 | 10 | 8 | 9 |
| material content | | | | | | |
| in porous | | | | | | |
| material (% by | | | | | | |
| mass) | | | | | | |
| Residual | 500 | 3400 | 3200 | 4400 | 600 | 4800 |
| monomer | | | | | | |
| (ppm) | | | | | | |
| Porosity (%) | 73 | 79 | 83 | 84 | 85 | 73 |
| Ave. pore | 56 | 21 | 35 | 68 | 126 | 36 |
| diameter (μm) | | | | | | |
| Ave. pore wall | 0.6 | 0.4 | 0.7 | 0.5 | 0.4 | 0.9 |
| thickness (μm) | | | | | | |
| Strength | 5 | 4 | 5 | 5 | 4 | 4 |
| Hydrolysis | 3 | 3 | 3 | 4 | 4 | 3 |
| resistance | | | | | | |

TABLE 8-1

| | Ex. 60 | Ex. 61 | Ex. 62 |
|---|---|---|---|
| Monomer 1 | L-lactide | L-lactide | L-lactide |
| Monomer 2 | D-lactide | D-lactide | ε- |
| | | | caprolactone |
| Catalyst | DBU | Tin | Tin |
| | | octylate | octylate |
| Initiator kind | Lauryl | Lauryl | Lauryl |
| | alcohol | alcohol | alcohol |
| Initiator amount | 0.02 | 0.02 | 0.02 |
| (mol %) | | | |
| Polymerization | 15 | 40 | 20 |
| pressure (MPa) | | | |
| Polymerization | 60 | 150 | 150 |
| temperature | | | |
| (° C.) | | | |
| Compressive | 20 | 20 | 20 |
| fluid mass ratio | | | |
| during | | | |
| polymerization | | | |
| (% by mass) | | | |
| Mw | 310000 | 560000 | 520000 |
| Mw/Mn | 1.3 | 1.6 | 1.4 |
| Residual monomer | 500 | 3000 | 2100 |
| (ppm) | | | |
| Porosity (%) | 73 | 81 | 84 |
| Ave. pore | 75 | 96 | 145 |
| diameter (μm) | | | |
| Ave. pore wall | 0.6 | 0.5 | 0.4 |
| thickness (μm) | | | |
| Strength | 3 | 5 | 5 |
| Hydrolysis | 5 | 4 | 4 |
| resistance | | | |

TABLE 8-2

| | Ex. 63 | Ex. 64 |
|---|---|---|
| Monomer 1 | L-lactide | L-lactide |
| Monomer 2 | D-lactide | ε- |
| | | caprolactone |
| Catalyst | DBU | DBU |
| Initiator kind | Lauryl | Lauryl |
| | alcohol | alcohol |
| Initiator amount | 0.02 | 0.02 |
| (mol %) | | |
| Inorganic | Hydroxy | Hydroxy |
| material | apatite | apatite |
| Compounding | 15 | 15 |
| amount of | | |
| inorganic | | |
| material (part | | |
| by mass) | | |
| Polymerization | 20 | 20 |
| pressure (MPa) | | |
| Polymerization | 60 | 150 |
| temperature | | |
| (° C.) | | |
| Compressive | 20 | 20 |
| fluid mass ratio | | |
| during | | |
| polymerization | | |
| (% by mass) | | |
| Mw | 350000 | 430000 |
| Mw/Mn | 1.4 | 1.5 |
| Inorganic | 14 | 13 |
| material | | |
| content in resin | | |
| porous material | | |
| (% by mass) | | |
| Residual | 1100 | 2800 |
| monomer | | |
| (ppm) | | |
| Porosity (%) | 74 | 83 |
| Ave. pore | 89 | 124 |
| diameter (μm) | | |
| Ave. pore wall | 0.8 | 0.5 |
| thickness (μm) | | |
| Strength | 4 | 5 |
| Hydrolysis | 3 | 4 |
| resistance | | |

TABLE 9

| | Comp. | Comp. | Comp. |
|---|---|---|---|
| | Ex. 1 | Ex. 2 | Ex. 3 |
| Monomer kind | L-lactide | L-lactide | L-lactide |
| Catalyst | DBU | Tin | Tin |
| | | octylate | octylate |
| Initiator kind | Lauryl | Lauryl | Lauryl |
| | alcohol | alcohol | alcohol |
| Initiator amount | 0.1 | 0.05 | 0.1 |
| (mol %) | | | |
| Polymerization | 20 | 20 | 20 |
| pressure (MPa) | | | |
| Polymerization | 60 | 150 | 150 |
| temperature | | | |
| (° C.) | | | |
| Compressive | 10 | 10 | 10 |
| fluid mass ratio | | | |
| during | | | |
| polymerization | | | |
| (% by mass) | | | |
| Compressive | 50 | 70 | 10 |
| fluid mass ratio | | | |
| during porosity | | | |
| imparting | | | |
| (% by mass) | | | |
| Mw | 290000 | 330000 | 280000 |
| Mw/Mn | 1.8 | 2.2 | 1.8 |
| Residual monomer | 2300 | 51000 | 14000 |
| (ppm) | | | |
| Porosity (%) | 72 | 63 | 57 |
| Ave. pore | 36 | 218 | 197 |
| diameter (μm) | | | |
| Ave. pore wall | 1.3 | 2.4 | 3.6 |
| thickness (μm) | | | |
| Strength | 1 | 2 | 1 |
| Hydrolysis | 1 | 1 | 1 |
| resistance | | | |

It was found out that the larger the molecular weight of the porous material, the higher the strength and hydrolysis resistance.

Aspect of the present invention are as follows, for example

<1> A porous material, including

at least one resin selected from the group consisting of an aliphatic polyester resin and an aliphatic polycarbonate resin,

wherein the porous material is made of the resin,

wherein the porous material is made of at least one resin selected from the group consisting of an aliphatic polyester resin and an aliphatic polycarbonate resin,

wherein a porosity of the porous material is 70% or higher, and

wherein a polystyrene equivalent weight average molecular weight of the resin measured by gel permeation chromatography is 300,000 or greater.

<2> The porous material according to <1>,

wherein the porous material includes a filler material.

<3> A shaped product, including

the porous material according to <1> or <2>.

<4> The shaped product according to <3>,

wherein the shaped product is any of a film, particles, and a molding.

<5> A method for producing the porous material according to <1> or <2>, including:

a polymerizing step of ring-opening polymerizing a ring-opening-polymerizable monomer in a mixture that includes the ring-opening-polymerizable monomer and a compressive fluid; and

a porosity imparting step of making the resin obtained in the polymerizing step porous by rapidly expanding the compressive fluid.

<6> The method for producing the porous material according to <5>,

wherein the porosity imparting step is a step of further mixing the resin obtained in the polymerizing step with a second compressive fluid, and after this, rapidly expanding the compressive fluid and the second compressive fluid.

<7> A serial producing apparatus for the porous material according to <1> or <2>, including:

a first supply unit configured to supply raw materials including a monomer;

a second supply unit configured to supply a compressive fluid;

a contact region in which the monomer and the compressive fluid are brought into contact with each other;

a reacting region in which the monomer undergoes a polymerization reaction in the presence of the compressive fluid;

a supply port through which a second compressive fluid is supplied to the resin obtained in the reacting region; and

a discharge port configured to discharge the resin obtained in the reacting region to thereby make the resin porous.

### REFERENCE SIGNS LIST

1 tank
9 contact region
13 reacting region
15 porosity imparting unit
21 tank
100 polymerization reaction apparatus
125 adding pot
127 reaction vessel
200 polymerization reaction apparatus
300 polymerization reaction apparatus
400 polymerization reaction apparatus
P resin porous material

1. A porous material, comprising
at least one resin selected from the group consisting of an aliphatic polyester resin and an aliphatic polycarbonate resin,
wherein the porous material is made of the resin,
wherein a porosity of the porous material is 70% or greater, and
wherein a polystyrene equivalent weight average molecular weight of the rein measured by gel permeation chromatography is 300,000 or greater.

2. The porous material according to claim 1,
wherein the porous material comprises a filler material.

3. A shaped product, comprising
the porous material according to claim 1.

4. The shaped product according to claim 3,
wherein the shaped product is any of a film, particles, and a molding.

5. A method for producing the porous material according to claim 1, comprising:
ring-opening polymerizing a ring-opening-polymerizable monomer in a mixture that comprises the ring-opening-polymerizable monomer and a compressive fluid; and
making the resin obtained in the ring-opening polymerization porous by rapidly expanding the compressive fluid.

6. The method for producing the porous material according to claim 5,
wherein in the making the resin porous, the resin obtained in the ring-opening polymerization is further mixed with a second compressive fluid, and after this, the compressive fluid and the second compressive fluid are rapidly expanded.

7. A serial producing apparatus for the porous material according to claim 1, comprising:
a first supply unit configured to supply raw materials that comprises a monomer;
a second supply unit configured to supply a compressive fluid;
a contact region in which the monomer and the compressive fluid are brought into contact with each other;
a reacting region in which the monomer undergoes a polymerization reaction in the presence of the compressive fluid;
a supply port through which a second compressive fluid is supplied to the resin obtained in the reacting region; and
a discharge port configured to discharge the resin obtained in the reacting region to thereby make the resin porous.
